(19) United States
(12) Patent Application Publication
(10) Pub. No.: US 2015/0032742 A1
(43) Pub. Date: Jan. 29, 2015

(54) COMMUNICATION MANAGEMENT SYSTEM, COMMUNICATION TERMINAL, COMMUNICATION SYSTEM, AND RECORDING MEDIUM

(71) Applicants: Shigeru NAKAMURA, Kanagawa (JP); Yoshiko AONO, Kanagawa (JP)

(72) Inventors: Shigeru NAKAMURA, Kanagawa (JP); Yoshiko AONO, Kanagawa (JP)

(21) Appl. No.: 14/329,039

(22) Filed: Jul. 11, 2014

(30) Foreign Application Priority Data
Jul. 24, 2013 (JP) 2013-153550

(51) Int. Cl. G06F 17/30

(52) U.S. Cl. CPC G06F 17/30861
USPC 707/736

(57) ABSTRACT

A communication management system receives a request for registering first candidate information for use by a communication terminal, obtains second candidate information available for use by the communication terminal, calculates a duplicate rate of member communication terminals, between the first candidate information and the second candidate information, and determines not to automatically register the first candidate information when the duplicate rate is at least greater than a threshold.

### CROSS-REFERENCE TO RELATED APPLICATIONS

This patent application is based on and claims priority pursuant to 35 U.S.C. §119 to Japanese Patent Application No. 2013-153550, filed on Jul. 24, 2013, in the Japan Patent Office, the entire disclosure of which is hereby incorporated by reference herein.

### BACKGROUND

1. Technical Field

The present invention generally relates to managing information regarding one or more candidate counterpart terminals for communication.

2. Description of the Related Art

With the need for reducing costs or times associated with business trips, more companies are moving towards communication systems to have communication among remotely located offices via a communication network such as the Internet or a leased line. To facilitate the process of selecting one or more counterpart communication terminals to start communication with, the user at a request communication terminal may previously generate a list of one or more candidates of counterpart communication terminals. Before starting communication, the user at the request communication terminal may easily select one or more counterpart communication terminals, from the list of candidate counterpart communication terminals being displayed.

### SUMMARY

In one aspect, a management system receives a request for registering first candidate information for use by a communication terminal, obtains second candidate information available for use by the communication terminal, calculates a duplicate rate of member communication terminals, between the first candidate information and the second candidate information, and determines not to automatically register the first candidate information when the duplicate rate is at least greater than a threshold.

Example embodiments of the present invention include a communication management system including: a receiver that receives a request for registering first candidate information for use by a communication terminal, from the communication terminal, the first candidate information indicating a first group of one or more member communication terminals; a memory that stores second candidate information available for use by the communication terminal, the second candidate information indicating a second group of one or more member communication terminals; and a processor that calculates a duplicate rate of member communication terminals, between the first candidate information and the second candidate information. When the duplicate rate is at least less than a threshold, the processor determines to automatically register the first candidate information. When the duplicate rate is at least greater than the threshold, the processor determines not to automatically register the first candidate information.

Example embodiments of the present invention include a communication terminal including: a transmitter that transmits a request for registering first candidate information for use by the communication terminal, to a communication management system, the first candidate information indicating a first group of one or more member communication terminals; a receiver that receives information regarding second candidate information available for use by the communication terminal, from the communication management system, the second candidate information indicating a second group of one or more member communication terminals, when a duplicate ratio of member communication terminals between the first candidate information and the second candidate information is at least greater than a threshold; and a user interface that receives a user instruction indicating whether to register the first candidate information for use by the communication terminal. The transmitter transmits the user instruction indicating whether to register the first candidate information to the communication management system.

The other example embodiments of the present invention include a method performed by the management system, a method performed by the communication terminal, a communication system including the communication management system and the communication terminal, and a non-transitory recording medium storing a control program that performs any one of the method to be performed by the management system, or by the communication terminal.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a configuration of a communication system according to an example embodiment of the present invention;

FIG. 2 is a perspective view illustrating the outer appearance of a communication terminal of the communication system of FIG. 1;

FIG. 3 is a schematic block diagram illustrating a hardware structure of the communication terminal of FIG. 2;

FIG. 4 is a schematic block diagram illustrating a hardware structure of any one of a management system, relay device, program providing system, and maintenance system, according to an example embodiment of the present invention;

FIG. 5 is a schematic block diagram illustrating a functional structure of the communication terminal and the management system of the communication system of FIG. 1;

FIG. 6 is an example data structure of an authentication management table, managed by the management system of FIG. 5;

FIG. 7 is an example data structure of a terminal management table, managed by the management system of FIG. 5;

FIG. 8 is an example data structure of a candidate list management table, managed by the management system of FIG. 5;

FIGS. 9A to 9C are example data structures of a group data management table, managed by the management system of FIG. 5;

FIG. 10 is an example data structure of a share request management table, managed by the management system of FIG. 5;

FIG. 11 is an illustration for explaining the concept of managing group information, performed by the communication system of FIG. 1;

FIG. 12 is a data sequence diagram illustrating operation of processing a login request to the management system of FIG. 5, performed by the communication system of FIG. 1, according to an example embodiment of the present invention;

FIG. 13 is a data sequence diagram illustrating operation of sending a share request to share a group member list with a share request destination terminal, performed by the communication system of FIG. 1, according to an example embodiment of the present invention;

FIG. 14 is an illustration of an example group name display screen;

FIG. 15 is an illustration of a share request destination selection screen;

FIG. 16 is a data sequence diagram illustrating operation of managing the group member list, performed by the management system of FIG. 1 in cooperation with the terminal, according to an example embodiment of the present invention;

FIG. 17 is an illustration of an example share request confirmation screen;

FIG. 18 is a flowchart illustrating operation of determining whether to register the group member list, performed by the management system of FIG. 1, according to an example embodiment of the present invention;

FIG. 19 is an illustration of an example screen, with information indicating that a group member list available for use exists;

FIG. 20 is an illustration of an example screen, with information regarding a group member list requested for use, and a group member list available for use;

FIG. 21 is a flowchart illustrating operation of determining whether to request approval to add the member terminal, performed by the management system of FIG. 1, according to an example embodiment of the present invention;

FIG. 22 is an illustration of an example member list screen;

FIG. 23 is a data sequence diagram illustrating operation of obtaining approval to add the member terminal, performed by the communication system of FIG. 1, according to an example embodiment of the present invention;

FIG. 24 is a flowchart illustrating operation of updating group information, performed by the management system of FIG. 1, according to an example embodiment of the present invention; and

FIG. 25 is a data sequence diagram illustrating operation of processing a request for selecting a counterpart terminal, performed by the communication system of FIG. 1, according to an example embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

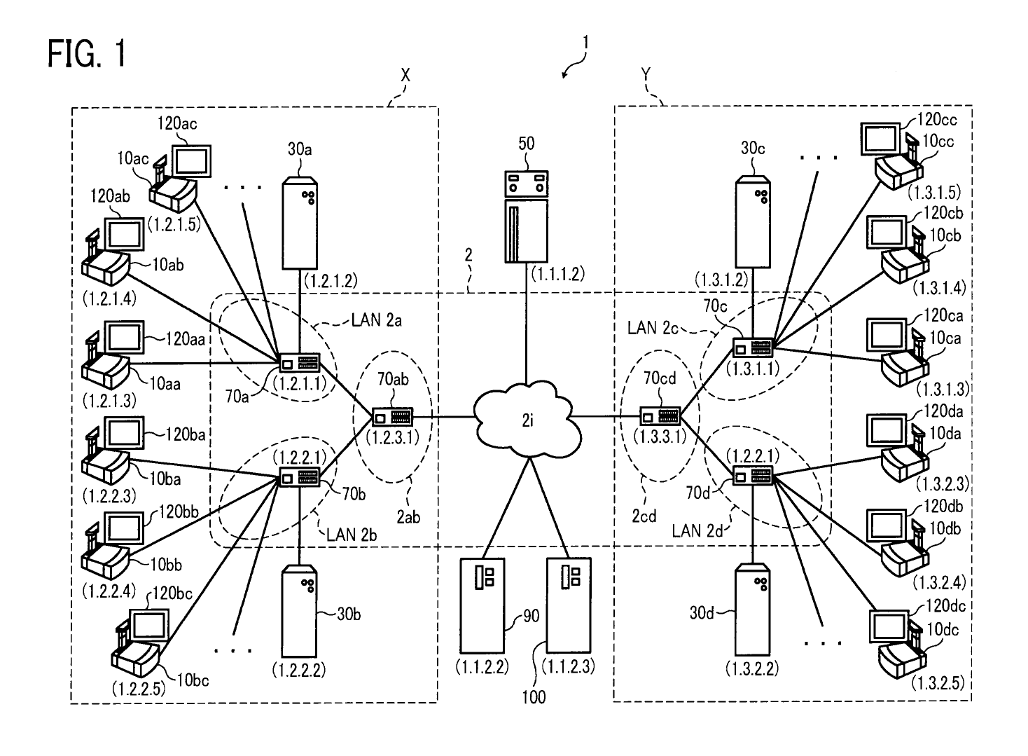

Referring to FIGS. 1 to 25, a communication system 1 is explained according to an example embodiment of the present invention. FIG. 1 illustrates a configuration of the communication system 1.

In the following examples, it is assumed that the communication system 1 of FIG. 1 is implemented as a communication system, which allows transmission of data or any information that reflects the feelings of a user, between or among a plurality of communication terminals 10 via a communication management system 50. Examples of the communication system include, but not limited to, a video communication system such as a videoconference system or a teleconference system.

In particular, in the following examples, it is assumed that the communication system 1 of FIG. 1 is implemented as the videoconference system, which is one example structure of the communication system. Based on this assumption, the communication management system 50 is implemented as the videoconference communication management system, which is one example structure of the communication management system. Further, the communication terminal 10 is implemented as the videoconference communication terminal, which is one example structure of the communication terminal. However, the use of communication system 1 is not limited to the following examples such that the communication system 1 may be implemented as any desired system other than the communication system described below.

The communication system 1 of FIG. 1 includes a plurality of communication terminals 10aa, 10ab, 10ac, 10ba, 10bb, 10bc, 10ca, 10cb, 10cc, 10da, 10db, and 10dc, a plurality of displays 120aa, 120ab, 120ac, 120ba, 120bb, 120bc, 120ca, 120cb, 120cc, 120da, 120db, and 120dc, a plurality of relay devices 30a, 30b, 30c, and 30d, the communication management system 50, a program providing system 90, and a maintenance system 100.

The communication terminal 10 transmits or receives contents data, such as image data and/or sound data, to or from another communication terminal 10.

For the descriptive purposes, in this example, any number of the plurality of communication terminals 10aa to 10dc may be collectively or each referred to as the terminal 10. Any number of the plurality of displays 120aa to 120dc may be collectively or each referred to as the display 120. Any one of the plurality of relay devices 30a, 30b, 30c, and 30d may be collectively or each referred to as the relay device 30. The communication management system 50 may be referred to as the “management system” 50.

The relay device 30 relays contents data, such as image data and/or sound data, between or among the plurality of terminals 10. The management system 50, which may be implemented by one or more computers to cooperatively function as a computer system, centrally manages various information such as login information of the terminal 10, the communication state of the terminal 10, candidate list information, and the communication state of the relay device 30.

The communication system 1 further includes a plurality of routers 70a, 70b, 70c, 70d, 70ab, and 70cd, which may be collectively or each referred to as the router 70. The router 70 selects a route that is most suitable for transmitting contents data such as image data and sound data. In this example, a moving image, a still image, or both of the still image and the moving image, may be transmitted as the image data.

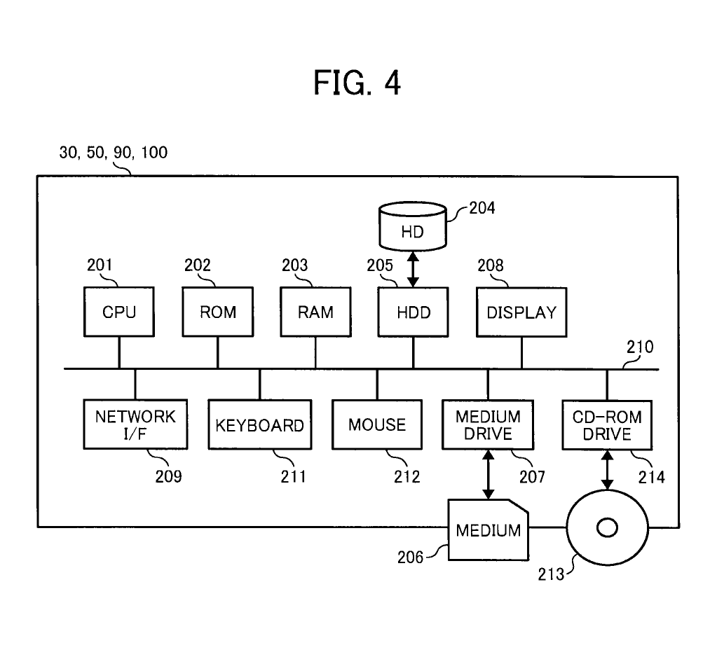

The program providing system 90 includes a hard disk device (HD) 204 (FIG. 4), which stores a terminal control program that causes the terminal 10 to perform various functions or operations. For example, the program providing system 90 sends the terminal control program to the terminal 10 through the Internet 2i to cause the terminal 10 to install the terminal control program. Further, the HD 204 of the program providing system 90 may store a relay control program that causes the relay device 30 to perform various functions or operations. For example, the program providing system 90 sends the relay control program to the relay device 30 through the Internet 2i to cause the relay device 30 to install the relay control program. Further, the HD 204 of the program providing system 90 may store a communication management program that causes the management system 50 to perform various functions or operations. For example, the program providing system 90 sends the communication management program to the management system 50 to cause the management system 50 to install the communication management program.

The maintenance system 100 is a computer system, which may be implemented by one or more computers, to maintain, manage, fix, or upgrade at least one of the terminal 10, relay device 30, management system 50, and program providing system 90. Assuming that the maintenance system 100 is provided within a country, and the terminal 10, relay device 30, management system 50, and program providing system 90 are each installed outside the country, the maintenance system 100 maintains, manages, fixes, or upgrades at least one of the terminal 10, relay device 30, management system 50, and program providing system 90, remotely through the communications network 2. The maintenance system 100 may manage maintenance of at least one of the terminal 10, relay device 30, management system 50, and program providing system 90 without using the communications network 2. For example, a machine type number, a manufacturing number, customer information, maintenance and repair information, and failure log information may be maintained at the maintenance system 100 without using the communications network 2.

Still referring to FIG. 1, the terminals 10aa, 10ab, and 10ac, the relay device 30a, and the router 70a are connected to a local area network (LAN) 2a. The terminals 10ba, 10bb, and 10bc, the relay device 30b, and the router 70b are connected to a LAN 2b. The LAN 2a and the LAN 2b are connected to a leased line 2ab in which the router 70ab is provided. It is assumed that the LAN 2a, LAN 2b, and the leased line 2ab, are within a private network X. For example, assuming that the private network X is managed by Company X, the LAN 2a corresponds to a network managed by a branch office “a”, and the LAN 2b corresponds to a network managed by a branch office “b”.

The terminals 10ca, 10cb, and 10cc, the relay device 30c, and the router 70c are connected to a LAN 2c. The terminals 10da, 10db, and 10dc, the relay device 30d, and the router 70d are connected to a LAN 2d. The LAN 2c and the LAN 2d are connected to a leased line 2cd in which the router 70cd is provided. It is assumed that the LAN 2c, LAN 2d, and leased line 2cd, are within a private network Y other than the private network X. For example, assuming that the private network Y is managed by Company Y, the LAN 2c corresponds to a network managed by a branch office “c”, and the LAN 2d corresponds to a network managed by a branch office “d”. The network X and the network Y are connected through the Internet 2i, via the routers 70ab and 70cd.

The management system 50 and the program providing system 90 are connected through the Internet 2i to the terminal 10 and the relay device 30. The management system 50 is made communicable with the terminal 10 and the relay device 30 through the communications network 2. Any one of the management system 50 and the program providing system 90 may be located at any network location within or outside any one of the network X and the network Y.

In this example, the communications network 2 includes the LAN 2a, LAN 2b, leased line tab, Internet 2i, leased line 2cd, LAN 2c, and LAN 2d. Any one or any portion of these lines or any other lines that may be included in the communications network 2 may be implemented as wired network or wireless network such as Wireless Fidelity (WiFi) network or Bluetooth network.

As illustrated in FIG. 1, the terminal 10, the relay device 30, the management system 50, the router 70, the program providing system 90, and the maintenance system 100 are each provided with four digit numbers. These four digit numbers separated by dots are the simple expressions of IP addresses respectively assigned to any one of the devices shown in FIG. 1, each of which has a function of communication device. For example, the IP address of the terminal 10aa is “1.2.1.3”. For simplicity, it is assumed that the IP address is expressed in IPv4. Alternatively, the IP address may be expressed in IPv6.

Further, in this example, the terminal 10 may be communicated in various ways, other than the example case in which the terminals 10 at different companies or different branch offices communicate with one another. For example, at least two different terminals 10 that are located at different rooms in the same office, or at least two different terminals 10 that are located at different offices that are remotely located from one another, may communicate with one another. In another example, at least two different terminals 10 that are located in the same room may communicate with one another. In another example, one terminal 10 that is located indoor and another terminal 10 that is located outdoor, or at least two different terminals 10 that are both located outdoor, may communicate with one another. When the terminal 10 is located outdoor, the terminal 10 communicates with the other terminal 10 through a wireless network such as a wireless network designed for a mobile phone.

<Hardware Structure of Communication System>

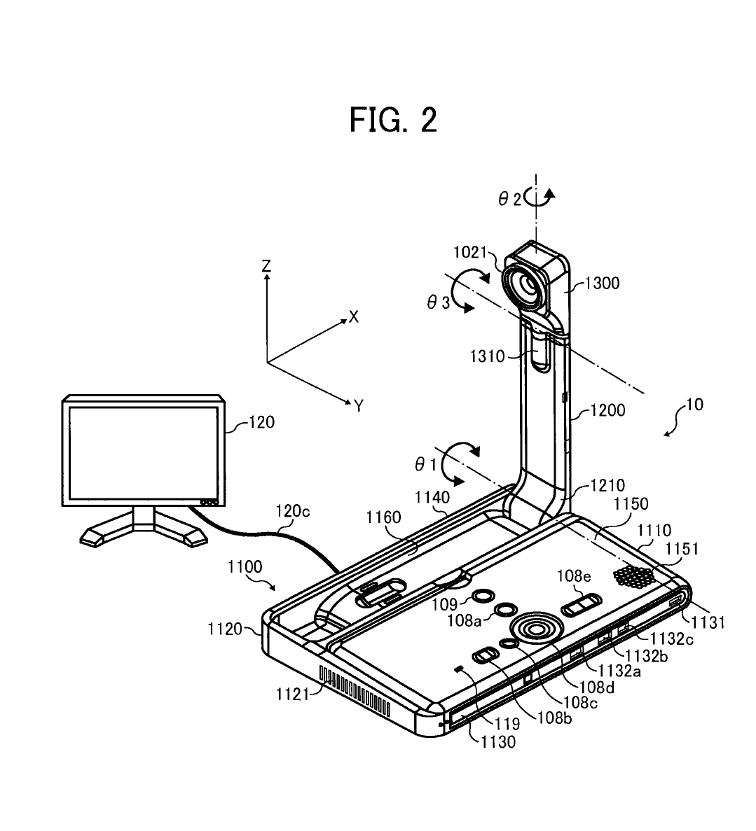

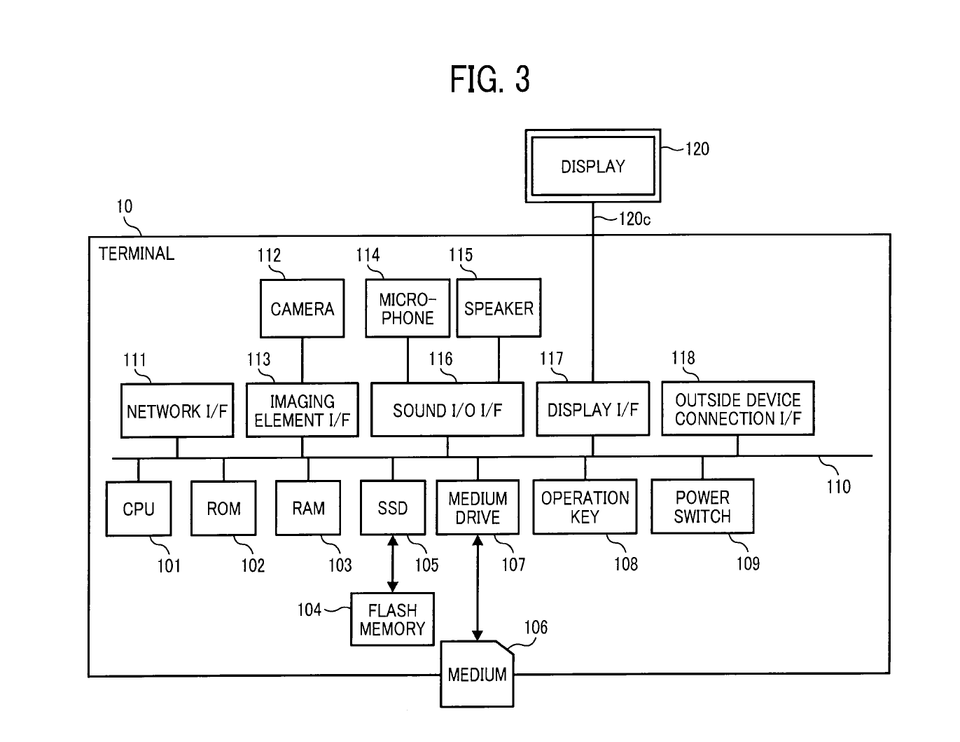

FIG. 2 is a perspective view illustrating the outer appearance of the communication terminal 10 of the communication system 1 of FIG. 1. In FIG. 2, the longitudinal direction of the terminal 10 is referred to as X direction. The direction orthogonal to the X direction, which is the horizontal direction of the terminal 10, is referred to as the Y direction. The direction orthogonal to the X direction and the Y direction is referred to as the Z direction. As illustrated in FIG. 2, the terminal 10 includes a body 1100, an arm 1200, and a camera housing 1300. The body 1100 includes a front side wall 1110 having a plurality of air intake holes that are formed over the nearly entire surface of the intake surface of the front side wall 1110. The body 1100 further includes a back side wall 1120 provided with an exhaust surface 1121 having a plurality of exhaust holes over the nearly entire surface of the exhaust surface 1121. When a cooling fan that is provided within the body 1100 is driven, air flows in through the intake holes of the intake surface and out through the exhaust holes of the exhaust surface 1121. The body 1100 further includes a right side wall 1130 formed with a sound pickup hole 1131. Through the sound pickup hole 1131, a microphone 114 (FIG. 3) of the terminal 10 is able to catch sounds such as human voice or any sound including noise.

The body 1100 has an operation panel 1150, which is provided at a front surface toward the right side wall 1130. The operation panel 1150 includes a plurality of operation keys 108a to 108e (“the operation key 108”), a power switch 109, an alarm lamp 119, and a plurality of sound output holes 1151. Through the sound output holes 1151, a speaker 115 (FIG. 3) of the terminal 10 is able to output sounds such as sounds generated based on human voice. The body 1100 further includes a holder 1160, which is provided at the front surface toward the left side wall 1140. The holder 1160, which has a concave shape, accommodates therein the arm 1200 and the camera housing 1300. The right side wall 1130 is further provided with a plurality of connection ports 1132a to 1132c (“connection ports 1132”). The connection ports 1132 allow electrical connection to an external device through an outside device connection I/F 118 (FIG. 3). The body 1100 further includes a left side wall 1140, which is provided with a connection port to connect the external display 120 to the display I/F 117 through a cable 120c.

The arm 1200 is attached to the body 1100 via a torque hinge 1210. With the torque hinge 1210, the arm 1200 can be rotated in directions of up and down with respect to the body, while making a tilt angle θ1 of up to 135 degrees. FIG. 2 illustrates the case where the tilt angle θ1 is 90 degrees.

The camera housing 1300 incorporates therein the camera 112 (FIG. 3) that takes an image of an object. The object may be a part of a user, document, or a room where the terminal 10 is located. The camera housing 1300 is provided with a torque hinge 1310. The camera housing 1300 is attached to the arm 1200 through the torque hinge 1310. With the torque hinge 1310, the camera housing 1300 can be rotated with respect to the arm 1200, in the direction of up, down, right, and left, such that the camera housing 1300 is kept at a desired position. More specifically, the camera housing 1300 can be rotated, while making a pan angle θ2 from about −180 degrees to 180 degrees in the direction right and left, and a tilt angle θ3 that ranges from about −45 degrees to +45 degrees in the direction of up and down. In FIG. 2, the pan angle θ2 and the tilt angle θ3 are each 0 degree.

In alternative to the outer appearance of FIG. 2, the communication terminal 10 may be implemented to have any other outer appearance. For example, the communication terminal 10 may look like the general-purpose PC, smart phone, or tablet. Further, the camera or the microphone does not have to be incorporated into the terminal 10, such that the camera or the microphone that is independent of the terminal 10 may be connected to the terminal 10.

The relay device 30, the management system 50, the program providing system 90, and the maintenance system 100 are each implemented by any desired number of general-purpose computers such as a personal computer or a server computer. For simplicity, explanation of the outer appearance of the computer is omitted.

FIG. 3 is a schematic block diagram illustrating a hardware structure of the communication terminal 10. As illustrated in FIG. 3, the terminal 10 includes a central processing unit (CPU) 101, a read only memory (ROM) 102, a random access memory (RAM) 103, a flash memory 104, a solid state drive (SSD) 105, a medium drive 107, the operation key 108, the power switch 109, a network interface (I/F) 111, the camera 112, an imaging element interface (I/F) 113, the microphone 114, the speaker 115, a sound input/output interface (I/O I/F) 116, the display interface (I/F) 117, and the outside device connection interface (I/F) 118, which are electrically connected through a bus 110 such as an address bus or data bus. The CPU 101 controls entire operation of the terminal 10. The ROM 102 stores therein a control program for execution by the CPU 101, such as an initial program loader (IPL). The RAM 103 functions as a work area for the CPU 101. The flash memory 104 stores therein various data such as the terminal control program, image data, or sound data such as voice data. The SSD 105 controls reading or writing of various data with respect to the flash memory 104 under control of the CPU 101. The medium drive 107 controls reading or writing of various data with respect to a removable recording medium 106 such as a flash memory. The operation key 108 allows the user to input a user instruction, for example, by allowing the user to select a communication destination such as the counterpart terminal 10. The power switch 109 allows the user to switch on or off the power of the terminal 10. The network I/F 111 allows the terminal 10 to transmit data through the communications network 2.

The camera 112 takes an image of an object to obtain image data under control of the CPU 101. The imaging element I/F 113 controls operation of the camera 112. The microphone 114 catches sounds such as voice of the user at the terminal 10. The speaker 115 outputs sounds such as sounds generated based on voice of the user at the counterpart terminal 10. The sound I/O I/F 116 controls input or output of sound signals such as voice signals with respect to the microphone 114 and the speaker 115 under control of the CPU 101. The display I/F 117 transmits image data to the display 120 under control of the CPU 101. The outside device connection I/F 118 controls connection of the terminal 10 to various types of outside device.

The display 120 may be implemented by a liquid crystal display (LCD) or an organic light emitting display, which displays various data such as an image of an object or an operation icon. As illustrated in FIGS. 2 and 3, the display 120 is connected to the display I/F 117 through the cable 120c. The cable 120c may be implemented by an analog RCB (VGA) signal cable, a component video cable, a high-definition multimedia interface (HDMI) signal cable, or a digital video interactive (DVI) signal cable.

The camera 112 includes a plurality of devices such as a lens system, and a solid-state image sensing device that photo-electrically converts a light to generate an image of an object. For example, the solid-state image sensing device includes a complementary metal oxide semiconductor (CMOS) or a charge coupled device (CCD).

The outside device connection I/F 118 may be connected to an outside device such as an external camera, external microphone, or external speaker through a universal serial bus (USB) cable that is connected through the port 1132 of the body 1100 (FIG. 2). When the external camera is connected to the terminal 10, the CPU 101 causes the terminal 10 to capture an image using the external camera, rather than the camera 112 that is incorporated in the terminal 10. When the external microphone or the external speaker is connected to the terminal 10, the CPU 101 causes the terminal 10 to use the external microphone or the external speaker in replace of the incorporated microphone 114 or the incorporated speaker 115.

The recording medium 106, which can be freely attached to or detached from the terminal 10, includes any desired type of recording medium. In alternative to the flash memory 104, any nonvolatile memory that is readable and writable under control of the CPU 101 may be used such as Electrically Erasable and Programmable ROM (EEPROM).

The terminal control program may be written onto a recording medium that is readable by a general-purpose computer such as the recording medium 106 in any format that is installable or executable by a general-purpose computer. Once the terminal control program is written onto the recording medium, the recording medium may be distributed. Further, the terminal control program may be stored in any desired memory other than the flash memory 104, such as the ROM 102.

FIG. 4 illustrates a hardware structure of the management system 50 of FIG. 1. The management system 50 includes a CPU 201, a ROM 202, a RAM 203, the HD 204, a hard disk drive (HDD) 205, a medium drive 207, a display 208, a network interface (I/F) 209, a keyboard 211, a mouse 212, and a CD-ROM drive 214, which are electrically connected through a bus 210 such as an address bus or a data bus.

The CPU 201 controls entire operation of the management system 50. The ROM 202 stores a control program for execution by the CPU 201, such as an IPL. The RAM 203 functions as a work area for the CPU 201. The HD 204 stores therein various data such as the communication management program. The HDD 205 controls reading or writing of various data with respect to the HD 204 under control of the CPU 201. The medium drive 207 controls reading or writing of various data with respect to a removable recording medium 206 such as a flash memory. The display 208 displays various data such as a cursor, menu, window, character, or image. The network I/F 209 allows the management system 50 to transmit data through the communications network 2. The keyboard 211 includes a plurality of keys, each of which is used for inputting a user instruction through a character, a numeral, or a symbol. The mouse 212 allows the user to input a user instruction including, for example, selection or execution of a specific instruction, selection of an area to be processed, and instruction of cursor movement. The CD-ROM drive 214 controls reading or writing of various data with respect to a CD-ROM 213. In alternative to the CD-ROM 213, any removable recording medium may be used.

The communication management program may be written onto a recording medium that is readable by a general-purpose computer such as the recording medium 206 or the CD-ROM 213 in any format that is installable or executable by a general-purpose computer. Once the communication management program is written onto the recording medium, the recording medium may be distributed. Further, the communication management program may be stored in any desired memory other than the HD 204, such as the ROM 202.

The relay device 30 is substantially similar in hardware structure to the management system 50 of FIG. 4, except for replacement of the management program with a relay device control program that is used for controlling the relay device 30. The relay device control program may be written onto a recording medium that is readable by a general-purpose computer such as the recording medium 206 or the CD-ROM 213 in any format that is installable or executable by the general-purpose computer. Once the relay device control program is written onto the recording medium, the recording medium may be distributed. Further, the relay device control program may be stored in any desired memory other than the HD 204, such as the ROM 202.

The program providing system 90 is substantially similar in hardware structure to the management system 50 of FIG. 4, except for replacement of the management program with a program providing program that is used for controlling the program providing system 90. The program providing program may be written onto a recording medium that is readable by a general-purpose computer such as the recording medium 206 or the CD-ROM 213 in any format that is installable or executable by the general-purpose computer. Once the program providing program is written onto the recording medium, the recording medium may be distributed. Further, the program providing program may be stored in any desired memory other than the HD 204, such as the ROM 202.

The maintenance system 100 is substantially similar in hardware structure to the management system 50 of FIG. 4, except for replacement of the management program with a maintenance program that is used for controlling the maintenance system 100. The maintenance program may be written onto a recording medium that is readable by a general-purpose computer such as the recording medium 206 or the CD-ROM 213 in any format that is installable or executable by the general-purpose computer. Once the maintenance program is written onto the recording medium, the recording medium may be distributed. Further, the maintenance program may be stored in any desired memory other than the HD 204, such as the ROM 202.

Other examples of removable recording medium, which may be used in replace of the CD-ROM 213, include, but not limited to, compact disc recordable (CD-R), digital versatile disk (DVD), and blue ray disc.

<Functional Structure of Communication System>

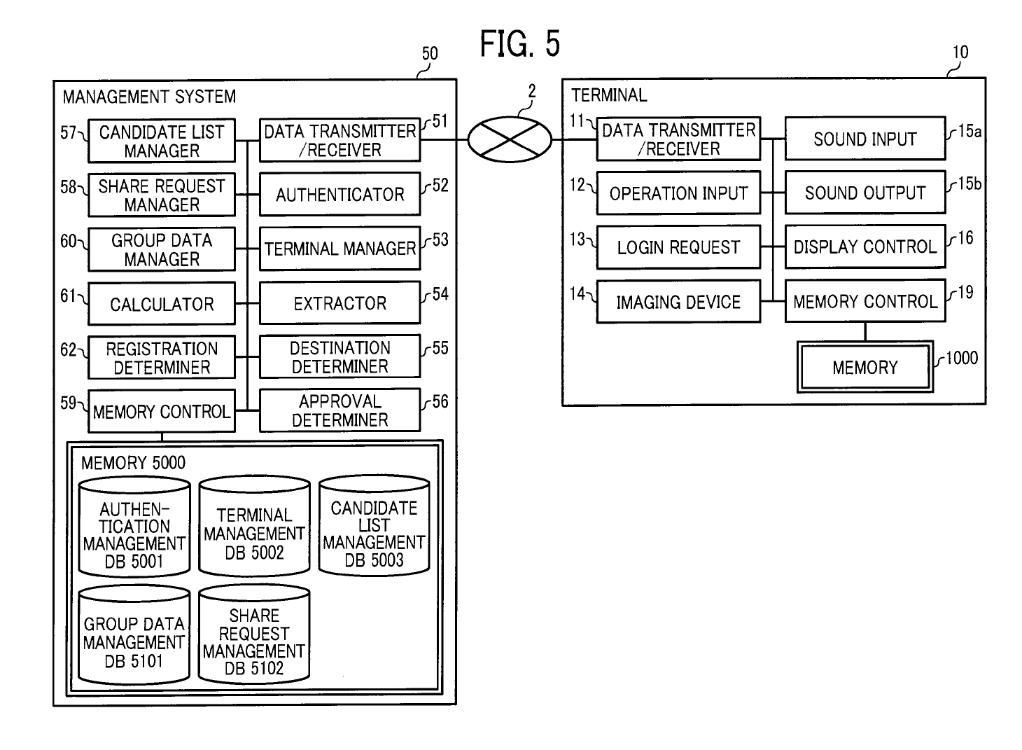

Next, a functional structure of the communication system 1 of FIG. 1 is explained according to an example embodiment of the present invention. FIG. 5 is a schematic block diagram illustrating a functional structure of the communication system 1. As illustrated in FIG. 5, the terminal 10 and the management system 50 exchange data with one another through the communications network 2. In FIG. 5, the relay device 30, the program providing system 90 and the maintenance system 100 of FIG. 1 are omitted.

<Functional Structure of Terminal>

The communication terminal 10 includes a data transmitter/receiver 11, an operation input 12, a login request 13, an imaging device 14, a sound input 15a, a sound output 15b, a display control 16, and a memory control 19. In this example, the operations or functions that are performed by the terminal 10, which include the operations or functions performed by the functional elements shown in FIG. 5, are performed in cooperation with one or more hardware devices of the terminal 10 that are shown in FIG. 3. More specifically, these elements shown in FIG. 5 correspond to a plurality of functions or functional modules, which are executed according to an instruction of the CPU 101 (FIG. 3) that is generated according to the program being loaded from the flash memory 104 onto the RAM 103. The terminal 10 further includes a memory 1000, which may be implemented by the RAM 103 or the flash memory 104 of FIG. 3.

The data transmitter/receiver 11 of the terminal 10, which may be implemented by the network I/F 111 (FIG. 3) under control of the CPU 101, transmits or receives various data or information to or from another terminal, device, or system, through the communications network 2. In this example, the data transmitter/receiver 11 starts receiving the operation state information that indicates the operation state of each candidate counterpart terminal 10 from the management system 50, before starting communication with any counterpart terminal 10. The operation state of the candidate counterpart terminal 10 indicates whether the candidate counterpart terminal 10 is online or offline. When the terminal 10 is online, the operation state of the candidate counterpart terminal 10 further indicates whether the candidate counterpart terminal 10 is available for communication (“communication OK”), the candidate counterpart terminal 10 is having communication with the other terminal (“communicating”), or the candidate counterpart terminal 10 is not available as the user leaves the seat. The operation state of the candidate counterpart terminal 10 may further indicate whether the candidate counterpart terminal 10 is online but in trouble or error (“online, communicating, trouble”), the candidate counterpart terminal 10 is online but not capable of outputting image data such that only sound data is output, or the candidate counterpart terminal 10 is online but in mute state (“online, mute”) such that sound data is not output. For example, when the cable 120c is disconnected from the terminal 10, the operation state of the candidate counterpart terminal 10 is assumed to be in the trouble state. For the descriptive purposes, in the following examples, it is assumed that the operation state information indicates whether the candidate counterpart terminal 10 is online or offline, and if online, whether the candidate terminal 10 is available for communication.

The operation input 12 receives a user instruction input by the user through the operation key 108 or the power switch 109 (FIG. 3), under control of the instructions received from the CPU 101.

The operations or functions of the login request 13 are performed according to an instruction received from the CPU 101 (FIG. 3). When the power of the terminal 10 is turned on, the login request 13 automatically causes the data transmitter/receiver 11 to send login request information that requests the login process, and a current IP address of the terminal 10, to the management system 50 through the communications network 2. When the power of the terminal 10 is turned off according to a user instruction received from the user through the power switch 109, the login request 13 causes the data transmitter/receiver 11 to send current operation state information of the terminal 10 to the management system 50, which indicates that the power of the terminal 10 is turned off. After the operation state information is sent, the operation input 12 turns off the power of the terminal 10. As the operation state information of the terminal 10 is sent every time the power is turned off, the management system 50 is able to know that the terminal 10 is offline in realtime.

The operations or functions of the imaging device 14 of the terminal 10 are performed by the camera 112 and the imaging element I/F 113 according to an instruction received from the CPU 101 (FIG. 3). The imaging device 14 takes an image of an object to output image data of the object.

The operations or functions of the sound input 15a of the terminal 10 are performed by the sound I/O I/F 116 according to an instruction received from the CPU 101, in cooperation with the microphone 114. After the microphone 114 converts sounds of the user at the terminal 10 to a sound signal, the sound input 15a inputs the sound signal in the form of sound data for further processing. The operations or functions of the sound output 15b of the terminal 10 are performed by the sound I/O I/F 116 according to an instruction received from the CPU 101, in cooperation with the speaker 115. The sound output 15b outputs a sound signal of sound data that is received from the counterpart terminal 10 through the speaker 115.

The operations or functions of the display control 16 of the terminal 10 of FIG. 5 are performed by the display I/F 117 according to an instruction received from the CPU 101 (FIG. 3). The display control 16 controls transmit of image data to the display 120.

The memory control 19 is implemented by the SSD 105 of FIG. 3 according to an instruction received from the CPU 101. The memory control 19 stores various data in the memory 1000, or reads out various data from the memory 1000. The memory 1000 stores therein various data such as terminal identification (ID) information for identifying the terminal 10, and a password for authenticating a user at the terminal 10. The memory 1000 further stores therein image data and/or sound data that is received as the terminal 10 communicates with a counterpart terminal 10 such that the image data and/or sound data are overwritten. Before the image data is overwritten, an image generated based on the image data is displayed onto the display 120. Before the sound data is output, sounds generated based on the sound data is output through the speaker 115.

In this example, any one of the terminal ID of the terminal 10 and the relay device ID of the relay device 30 includes any type of identification information that can be expressed by any language, character, symbol, mark, or any combination of language, character, symbol, and mark.

<Functional Structure of Management System>

The management system 50 includes a data transmitter/receiver 51, an authenticator 52, a terminal manager 53, an extractor 54, a destination determiner 55, an approval determiner 56, a candidate list manager 57, a share request manager 58, a group data manager 60, a calculator 61, a registration determiner 62, and a memory control 59. These units shown in FIG. 5 correspond to a plurality of functions or functional modules, which are executed according to an instruction of the CPU 201 (FIG. 4) that is generated according to the communication management program being loaded from the HD 204 onto the RAM 203. The management system 50 further includes a memory 5000, which may be implemented by the HD 204 (FIG. 4). The memory 500 stores various data or information.

(Authentication Management Table)

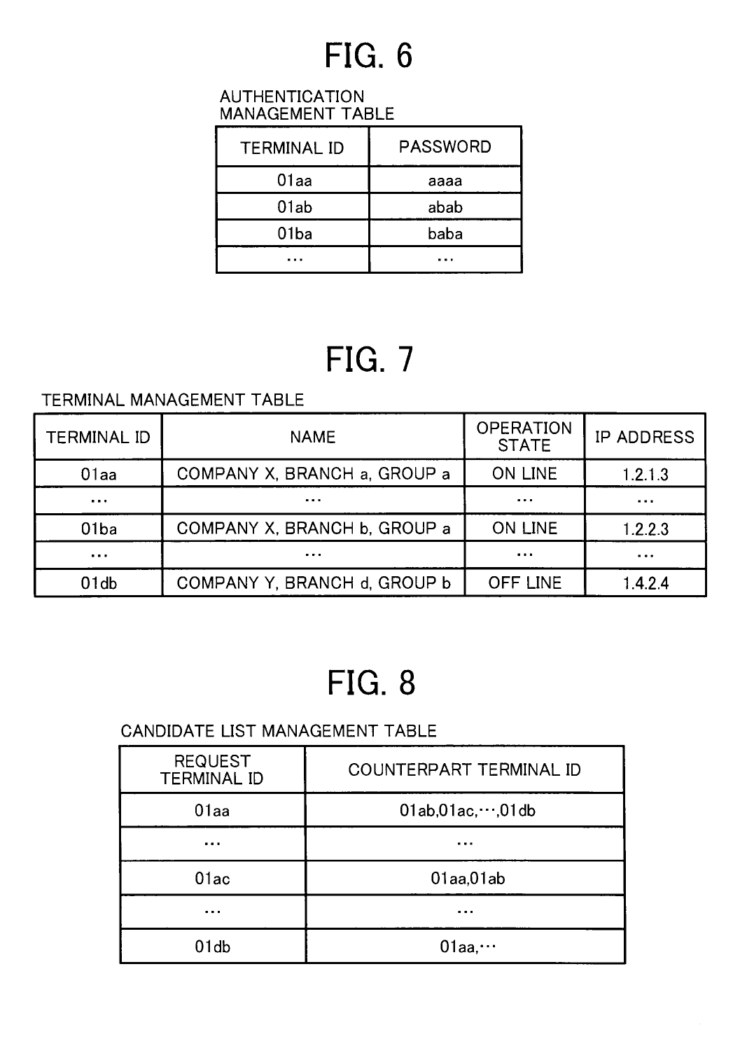

The memory 5000 includes an authentication management database (DB) 5001, which stores therein an authentication management table of FIG. 6. The authentication management table of FIG. 6 stores, for each one of the terminals 10 that are managed by the management system 50, the terminal ID and the password in association with each other. For example, referring to FIG. 6, the terminal 10aa has the terminal ID “01aa” and the password “aaaa”.

(Terminal Management Table)

The memory 5000 further includes a terminal management DB 5002, which stores therein a terminal management table of FIG. 7. The terminal management table of FIG. 7 stores, for each one of the terminal IDs assigned to the terminals 10, the terminal name of the terminal 10, the operation state of the terminal 10, and the IP address of the terminal 10, in association with one another. For example, for the terminal 10aa having the terminal ID “01aa”, the terminal management table of FIG. 7 indicates that the terminal name is “Company X, Branch a, Group a”, the operation state is online (“ONLINE”), and the IP address of the terminal 10aa is “1.2.1.3”.

(Candidate List Management Table)

The memory 5000 further includes a candidate list management DB 5003, which stores therein a candidate list management table of FIG. 8. The candidate list management table of FIG. 8 stores, for each one of a plurality of request terminals 10 capable of requesting for videoconference communication, the terminal ID of the request terminal 10, and one or more terminal IDs that are respectively assigned to candidate counterpart terminals 10 that are previously registered for the request terminal 10. In this example, for the request terminal 10, one or more terminals 10 of the communication system 1 of FIG. 1 are previously registered as the candidate counterpart terminal 10. For example, the candidate list management table of FIG. 8 indicates that the request terminal 10aa having the terminal ID “01aa” can request for videoconference with respect to the terminal 10ab having the terminal ID “01ab”, the terminal 10ac having the terminal ID “01ac”, and the terminal 10db having the terminal ID “01db”, etc. The management system 50 manages the candidate list management table of FIG. 8, for example, according to a user instruction received from any one of the terminals 10. For example, in response to a user instruction received from the terminal 10aa, the management system 50 may add or delete the contents of the candidate list management table of FIG. 8.

(Group Data Management Table)

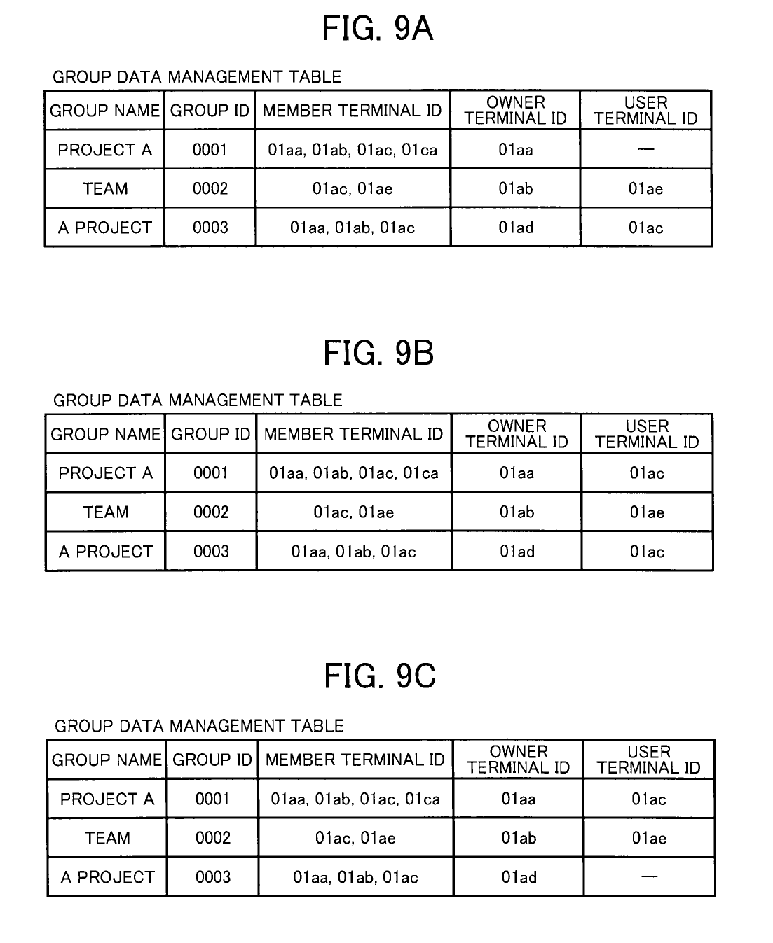

The memory 5000 further includes a group data management DB 5101, which stores therein a group data management table of any one of FIGS. 9A to 9C (collectively referred to as FIG. 9). The group data management table of FIG. 9 stores, for each group, a group name, a group ID, a member terminal ID, an owner terminal ID, and a user terminal ID, in association with one another. The group ID is any identification information that identifies a specific group. The member terminal ID is a terminal ID that identifies each one of the terminals 10 (“member terminal”) belonging to the specific group. In this example, assuming that the user at the terminal 10aa creates a specific group, each one of the member terminals belonging to the specific group is registered as a candidate counterpart terminal for the terminal 10aa that is the request terminal 10aa. The owner terminal ID is a terminal ID that identifies the terminal 10 of an owner user who owns a group member list for the specific group. More specifically, the owner user is capable of requesting addition or deletion of a member terminal to or from the specific group, or capable of requesting to share a group member list with another terminal 10. The user terminal ID is a terminal ID that identifies the terminal 10, other than the owner terminal of the group member list, which is capable of using the group member list. For example, the user terminal may be the terminal of the user who is requested by the owner user to share the group member list.

As described below, in this example, it is assumed that the memory 5000 stores the group data management table of FIG. 9A.

Referring to FIG. 9A, the group data management table stores various information (“group information”) regarding a specific group with the group ID “0002”. The group name of the group having the group ID “0002” is “TEAM”. The member terminals of the group “TEAM” includes the terminal 10ac having the terminal ID “01ac” and the terminal 10ae having the terminal ID “01ae”. The owner terminal of the group “TEAM” is the terminal Mac having the terminal ID “01ab”. The user terminal of the group “TEAM” is the terminal 10ae having the terminal ID “01ae”. The group information such as the group member list for the group “TEAM” can be used by the owner terminal 10ab and the user terminal 10ae.

(Share Request Management Table)

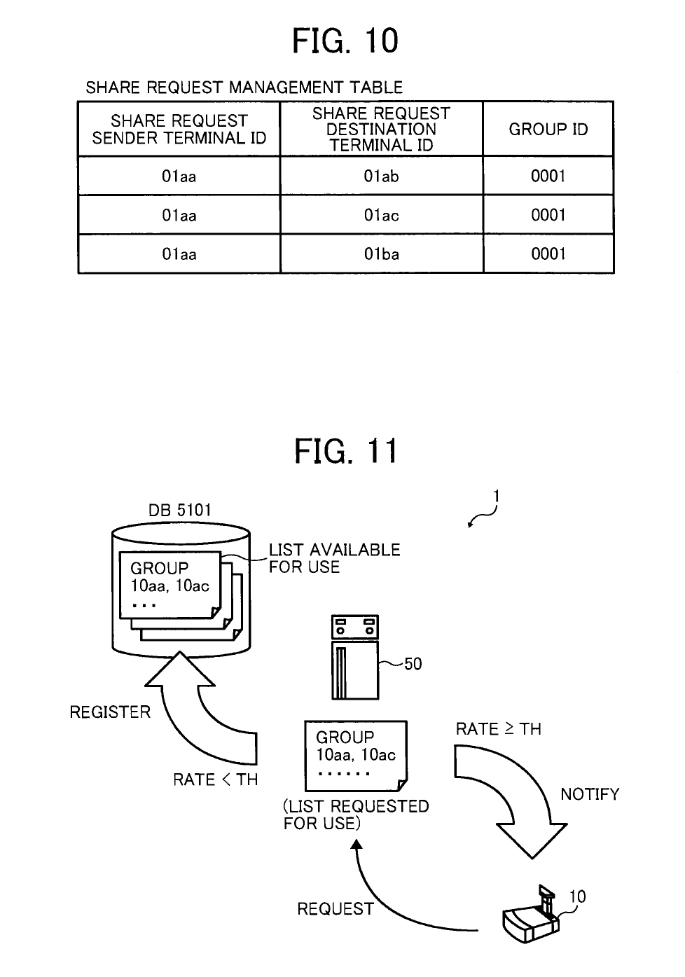

The memory 5000 further includes a share request management DB 5102, which stores therein a share request management table of FIG. 10. The share request management table of FIG. 10 stores a share request sender terminal ID, a share request destination terminal ID, and a group ID, in association with one another. The share request sender terminal ID is a terminal ID that identifies the terminal 10 (“share request sender terminal”), which sends a share request to a specific terminal 10 (“share request destination terminal”). The share request requests sharing of group information regarding a specific group, such as a group member list, with the share request destination terminal 10. With the group member list, the share request destination terminal 10 is able to select one or more members belonging to the specific group as a candidate counterpart terminal, with improved efficiency. The share request destination terminal ID is a terminal ID that identifies the share request destination terminal, which is to receive group information regarding the specific group, such as the group member list.

(Functional Structure of Management System)

Referring back to FIG. 5, the data transmitter/receiver 51, which may be implemented by the network I/F 209 (FIG. 4) according to an instruction received from the CPU 201, transmits or receives various data or information to or from another terminal, device, or system through the communications network 2.

The authenticator 52, which may be implemented by the instructions from the CPU 201 (FIG. 4), obtains a terminal ID and a password from the login request information that is received from the data transmitter/receiver 51. Using the terminal ID and the password as a search key, the terminal authenticator 52 searches the authentication management DB 5001 (FIG. 6) to determine whether the obtained set of terminal ID and password is registered. Based on the search result, the terminal authenticator 52 determines whether the user at the terminal 10 or the terminal 10 is allowed for access.

The terminal manager 53, which may be implemented by the instructions from the CPU 201 (FIG. 4), manages the operation state of the request terminal 10 that sends the login request information using the terminal management DB 5002 (FIG. 7). More specifically, the terminal manager 53 stores the terminal ID of the request terminal 10, the operation state of the request terminal 10, and the IP address of the request terminal 10, in association with one another. When the power switch 109 is changed from the “ON” state to the “OFF” state by the user, the terminal manager 53 receives the operation state information indicating that the power is turned off from the terminal 10, and changes the operation state of the terminal 10 from the “online” state to the “offline” state in the terminal management table of FIG. 7.

The extractor 54, which may be implemented by the instructions received from the CPU 201 (FIG. 4), extracts various information from the memory 5000. In one example, it is assumed that the user at the request terminal 10 is about to start communication with one or more users who belong to a specific group. In such case, in response to receiving the group ID through the data transmitter/receiver 51 from the request terminal 10, the extractor 54 extracts the member terminal ID, which is associated with the received group ID, from the group data management table of FIG. 9. The extractor 54 searches the candidate list management table of FIG. 8 using the terminal ID of the request terminal 10, to obtain the terminal ID of the candidate counterpart terminal 10 that can communicate with the request terminal 10. Based on a match between the member terminal ID and the candidate counterpart terminal ID, the extractor 54 searches the terminal management table of FIG. 7 using the terminal ID of the candidate counterpart terminal 10 that is also registered as the member terminal, as a search key, to obtain the operation state of the candidate counterpart terminal 10. In this manner, the extractor 54 is able to obtain the operation state of the candidate counterpart terminal 10 that belongs to the specific group and can communicate with the request terminal 10, for each one of the candidate counterpart terminals 10, for display to the terminal 10.

The destination determiner 55, which may be implemented by the instructions from the CPU 201 (FIG. 4), determines whether the member terminal belonging to a specific group has been registered as a candidate counterpart terminal for the request terminal 10 that may start communication with the member terminal. In one example, the destination determiner 55 determines whether the member terminal ID is stored in the candidate list management table of FIG. 8, as a candidate counterpart terminal ID that is associated with a request terminal ID of the request terminal 10.

The approval determiner 56 determines whether to require approval to newly register the unregistered terminal to the candidate list management table (FIG. 8) in association with the share request destination terminal. The approval determiner 56 may be implemented by the instructions from the CPU 201.

The candidate list manager 57, which may be implemented by the instructions from the CPU 201 (FIG. 4), adds or deletes the candidate counterpart terminal ID that is to be associated with the request terminal ID, to or from the candidate list management DB 5003 (FIG. 8).

The share request manager 58, which may be implemented by the instructions received from the CPU 201 of FIG. 4, manages various information regarding the share request using the share request management table (FIG. 10). More specifically, the share request manager 58 may manage each record in the share request management table (FIG. 10), for example, by adding or deleting information such as the share request sender terminal ID and the share request destination terminal ID.

The group data manager 60, which may be implemented by the instructions from the CPU 201, manages various information regarding one or more groups using the group data management table (FIG. 9). More specifically, the group data manager 60 may add or delete, to or from each record, group information such as the group name, group ID, member terminal ID, owner terminal ID, and user terminal ID.

The calculator 61 calculates the duplicate rate between the member terminals included in the group member list that is requested to share with a specific terminal 10, and the member terminals included in the group member list that is available for use by the specific terminal 10.

The registration determiner 62 determines whether to register the group member list that is requested to share, as the group member list to be used by the specific terminal 10, based on the calculation result of the calculator 61 and a threshold of the duplicate rate that is obtained from the memory 5000.

The memory control 59, which operates according to an instruction received from the CPU 201 (FIG. 4) in cooperation with the HDD 205 (FIG. 4), stores various data in the memory 5000 or read out various data from the memory 5000.

<Operation>

Referring to FIG. 11, the concept of managing group information, which may be requested by a specific terminal to share with another terminal, performed by the communication system 1, is explained according to an example embodiment of the present invention.

The management system 50 manages group information (one example of candidate information) regarding one or more groups, such as one or more group member lists each of which lists the terminal IDs of the member terminals, using the group data management DB 5101. With the use of group member list, the user at the terminal 10 can select one or more member terminals to have communication with, with improved efficiency. For example, the user may previously store a group member list, which lists one or more member terminals, for a specific group. In this example, it is assumed that the group member list includes the terminal ID 01aa of the member terminal 10aa and the terminal ID 01ca of the member terminal 10ca.

The user may sometimes want to share this group member list with the other user, such as the other member users in that group. However, simply providing the group member list to the other user may result in increase in number of group member lists, thus making difficult for the other user to select a counterpart terminal for communication.

In view of this, as described below, the management system 50 in this example embodiment calculates a duplicate rate between one or more terminals included in the group member list subjected for sharing with a specific terminal, and one or more terminals being managed by the management system 50 for the specific terminal. When the duplicate rate is equal to or greater than a predetermined threshold, or exceeds a predetermined threshold, the management system 50 does not register the group member list that is requested to share with the specific terminal. This suppresses the number of group member lists to be registered.

More specifically, it is assumed that the data transmitter/receiver 51 of the management system 50 receives a request for registering a group member list for use by the terminal 10ac, from the terminal 10ac. The calculator 61 of the management system 50 calculates a duplicate rate between the member terminal IDs of the group member list requested for use, and the member terminal IDs being managed by the group data management DB 5101 for the terminal 10ac. When the calculated duplicate rate is less than, or equal to or less than, the predetermined threshold, the group data manager 60 registers the group member list to the group data management DB 5101 for use by the terminal 10ac. When the calculated duplicate rate is equal to or greater than, or exceeds, the predetermined threshold, the group data manager 60 does not register the group member list to the group data management DB 5101. This suppresses the increase in number of group member lists to be managed using the group data management DB 5101 for use by the terminal 10ac. With this configuration, the user may easily select a candidate counterpart terminal with improved efficiency.

In one example, the data transmitter/receiver 51 of the management system 50 receives information indicating whether to register one or more member terminals included in the group member list, from the terminal 10ac, when the calculated duplicate rate exceeds, or is equal to or greater than, the predetermined threshold. In response to the request for registering the member terminals, which is received at the data transmitter/receiver 51, the group data manager 60 registers the member terminals included in the group member list to the group data management DB 5101. With this configuration, flexibility in managing the group member list increases.

For example, when the duplicate rate exceeds, or is equal to or greater than, the predetermined threshold, the data transmitter/receiver 51 outputs information regarding the group member list being managed by the group data management DB 5101 for the terminal 10ac, for example, for display to the user at the terminal 10ac. The user is able to compare, between the group member list to be registered, and the group member list being managed by the group data management DB 5101. Based on comparison, the user is able to determine whether to register the group member list to the group data management DB 5101, in addition to the group member list being managed for use by the terminal 10ac.

In this example, the duplicate rate is obtained as a ratio of the number of member terminals included in the group member list available for use by a specific terminal, with respect to the number of member terminals included in the group member list requested for use by the specific terminal. The group member list available for use has been registered to the group data management DB 5101, while the group member list requested for use is not registered to the group data management DB 5101.

Further, when the calculated duplicate rate exceeds, or is equal to or greater than, the predetermined threshold, the data transmitter/receiver 51 of the management system 50 accepts a user request for registering the group member list in replace of the corresponding group member list being currently managed by the group data management DB 5101. In response to such request, the group data manager 60 registers the group member list requested for use, while modifying data of the group member list being managed by the group data management DB 5101 for use by the terminal 10ac. This suppresses the increase in number of group member lists to be managed. Modification of data includes, but not limited to, overwriting data in the registered group member list with data in the group member list to be registered, and deleting data from the registered group member list.

For example, the operation input 12 of the terminal 10ac receives a user input that requests for registering a group member list to the group data management DB 5101 such that the group member list can be used by the terminal 10ac. In response to the user input, the data transmitter/receiver 11 of the terminal 10ac transmits request information to the management system 50.

For example, the operation input 12 of the terminal 10ac receives a user input regarding whether to request registration of a group member list to the group data management DB 5101. In response to the user input, the data transmitter/receiver 11 of the terminal 10ac transmits information indicating whether to request for registration of the group member list to the management system 50.

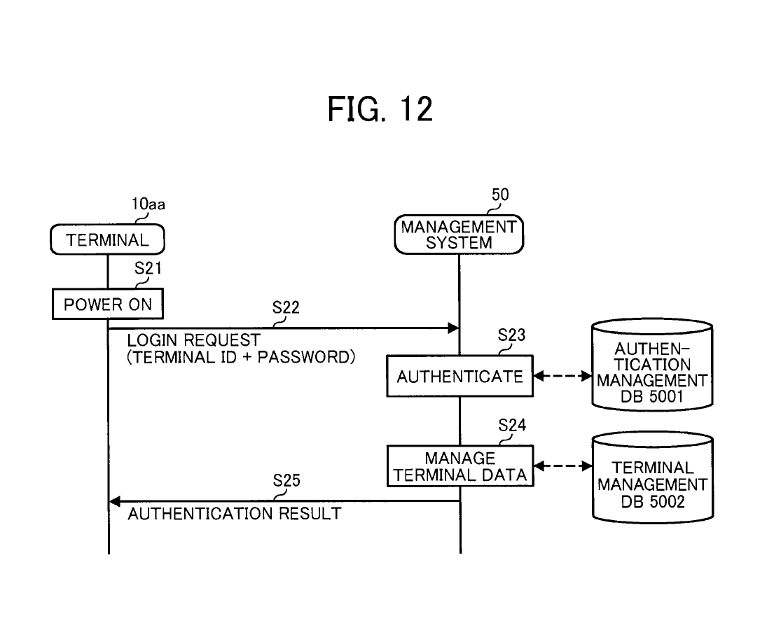

Referring now to FIGS. 12 to 25, operation of managing group information such as a group member list is explained according to an example embodiment of the present invention. FIG. 12 is a data sequence diagram illustrating operation of processing a login request transmitted from the terminal 10aa to the management system 50, according to an example embodiment of the present invention.

At S21, as the user at the terminal 10aa turns on the power switch 109 (FIG. 3), the operation input 12 (FIG. 5) of the terminal 10aa receives an instruction for turning on the power, and turns on the power of the terminal 10aa.

In response to turning on of the power, at S22, the login request 13 automatically sends login request information to request for logging in, to the management system 50, through the data transmitter/receiver 11 via the communications network 2. The login request information includes the terminal ID that identifies the request terminal 10aa, and the password associated with the terminal ID. The terminal ID and the password may be obtained by the memory control 19 from the memory 1000, and sent to the data transmitter/receiver 11. At the time of sending the login request information from the request terminal 10aa to the management system 50, the request terminal 10aa sends an IP address of the request terminal 10aa such that the management system 50 knows the IP address of the request terminal 10aa.

At S23, the authenticator 52 of the management system 50 searches the authentication management DB 5001 (FIG. 6) stored in the memory 5000 using the terminal ID and the password of the login request information received through the data transmitter/receiver 51. When it is determined that the terminal ID and the password of the login request information is stored in the authentication management DB 5001, the authenticator 52 determines that the terminal 10aa is authenticated.

At S24, when the authenticator 52 authenticates that the login request information is received from the authenticated terminal 10, the terminal manager 53 of the management system 50 stores the operation state and the IP address of the terminal 10aa, in association with the terminal ID and the terminal name in the terminal management DB 5002 (FIG. 7) to create a record of the terminal 10aa. The terminal management table of FIG. 7 is able to manage the operation state “online” and the IP address “1.2.1.3” in association with the terminal ID “01aa”.

At S25, the data transmitter/receiver 51 of the management system 50 sends the authentication result obtained by the authenticator 52 to the request terminal 10aa that has sent the login request information through the communications network 2. As described above, in this example, it is assumed that the authenticator 52 determines that the terminal 10aa is an authenticated terminal.

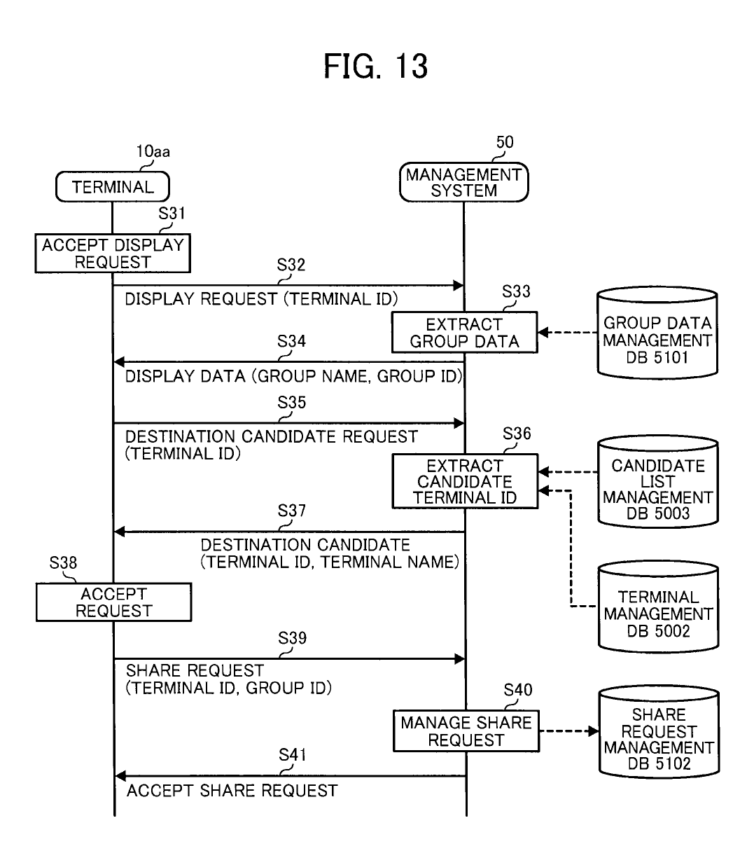

Referring to FIG. 13, operation of processing a request (“share request”) to share a group member list of a group assigned with the group ID “0001” with a terminal 10ac, issued by a terminal 10aa, performed by the communication system 1, is explained according to an example embodiment of the present invention.

At S31, the operation input 12 of the request terminal 10aa receives a request for displaying group information such as a group name of a group owned by the request terminal 10aa, through operations performed on the operation key 108.

In response to the request, at S32, the data transmitter/receiver 11 of the request terminal 10aa sends group display request information (“group display request”) to the management system 50 through the communications network 2. The group display request information includes the terminal ID “01aa” of the request terminal 10aa. The data transmitter/receiver 51 of the management system 50 receives the group display request information.

At S33, the extractor 54 of the management system 50 searches the group data management table (FIG. 9A) using the terminal ID “01aa” included in the group display request information as a search key to obtain a record for the owner terminal ID “01aa”. In this example, the extractor 54 obtains the group name “Project A” and the group ID “0001”, which are associated with the own terminal ID “01aa”, which matches the terminal ID “01aa” of the terminal 10aa sending the request. The extractor 54 may further obtain any other information regarding the group, from the group data management table of FIG. 9A.

At S34, the data transmitter/receiver 51 of the management system 50 sends group data including the group name and the group ID, which are extracted at S33, to the request terminal 10aa through the communications network 2. The request terminal 10aa receives the group data at the data transmitter/receiver 11.

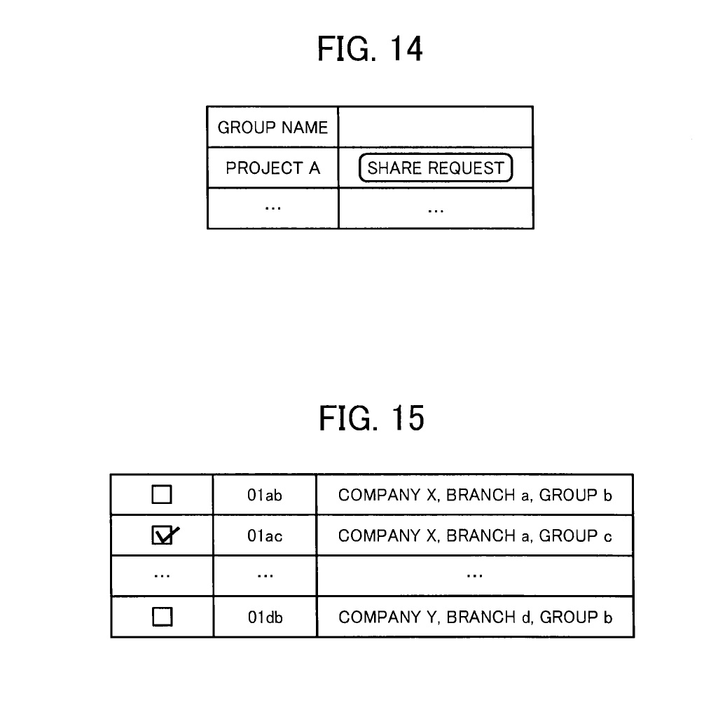

The display control 16 of the terminal 10aa generates a group name display screen, which shows a group name of one or more groups owned by the request terminal 10aa, based on the group data, and instructs the display 120 (FIG. 3) to display the group name display screen, for example, as illustrated in FIG. 14. FIG. 14 is an example group name display screen, which shows a group name of the group owned by the terminal 10aa. In addition to the group name, any other information such as the group ID may be displayed. In this example of FIG. 14, the group name display screen further includes the “SHARE REQUEST” key, which allows sharing of the group member list for that group with another terminal.

Assuming that the user at the request terminal 10aa selects the “SHARE REQUEST” key for the selected group on the group name display screen using the operation key 108, the operation input 12 accepts a share request for sharing a member list of the selected group with another terminal.

At S35, the data transmitter/receiver 11 of the request terminal 10aa sends a share request destination candidate request (“destination candidate request”), which requests information regarding a candidate to share the group member list, to the management system 50 through the communications network 2. The destination candidate request includes the terminal ID “01aa” of the request terminal 10aa, and the group ID of the selected group. In case only one group is available for the request terminal 10aa, identification information such as the group ID may not be sent.

In response to the destination candidate request that is received at the data transmitter/receiver 51 of the management system 50, at S36, the extractor 54 searches the candidate list management table (FIG. 8) using the terminal ID “01aa” included in the destination candidate request as a search key to obtain one or more candidate counterpart terminal IDs, which are associated with the request terminal ID “01aa”. The extractor 54 further obtains the name of the terminal that is associated with each one of the candidate counterpart terminal IDs that are extracted, from the terminal management DB 5002 (FIG. 7).

In this example, the extractor 54 extracts the terminal ID “01ab”, “01ac”, . . . , and “01db” of the candidate counterpart terminals 10ab, 10ac, . . . , and 10db, which are associated with the terminal ID “01aa” of the request terminal 10ac, from the candidate list management table of FIG. 8. Further, the extractor 54 extracts the terminal names “Company X, Brach a, Group b”, “Company X, Branch a, Group c”, . . . , and “Company Y, Branch d, Group b”, which are associated with the terminals 10ab, 10ac, . . . 10db, respectively, from the terminal management table of FIG. 7.

In this example, it is assumed that a share request destination candidate is one of candidate counterpart terminals of the request terminal 10aa. Alternatively, the share request destination candidate may be any desired one or more of the group member terminals in the group member list. In such case, the extractor 54 searches the group data management DB 5101 of FIG. 9A, using the terminal ID “01aa” as a search key to obtain the member terminal IDs that are associated with the owner terminal ID “01aa”.

At S37, the data transmitter/receiver 51 of the management system 50 sends share request destination candidate information (“destination candidate information”), which includes the destination candidate terminal IDs, and the terminal names of the destination candidate terminals, to the terminal 10aa. The data transmitter/receiver 11 of the request terminal 10aa receives the destination candidate information. As described above, the destination candidate terminal may be any one of candidate counterpart terminals associated with the terminal 10aa in the candidate list, and/or the member terminals associated with the terminal 10aa in the group member list.

At S38, the display control 16 of the terminal 10aa generates a screen including the destination candidate terminal ID and the destination candidate terminal name, which are included in the destination candidate information received from the management system 50, and outputs the screen through the display 120 (FIG. 3), for example, as illustrated in FIG. 15.

FIG. 15 is an illustration of a share request destination selection screen, which may be displayed through the display 120aa. More specifically, in this example, the member terminals 10ab, 10ac, and 10ca of the group “0001” except for the request terminal 10aa, and the counterpart terminals 10ab, 10ac, and 10db for the request terminal 10aa, can be displayed.

Assuming that a check box for the terminal name “Company X, Branch a, Group c” of the terminal 10ac on the selection screen of FIG. 15 is selected, for example, through the operation key 108, at S38, the operation input 12 accepts the user selection that selects the terminal 10ac as a share request destination terminal.

At S39, the data transmitter/receiver 11 of the terminal 10aa sends share request information, that is, a share request for requesting to share a group member list with the selected terminal 10ac, to the management system 50 through the communications network 2. The share request includes the terminal ID “01aa” of the request terminal 10aa, the terminal ID “01ac” of the share request destination terminal 10ac, and the group ID “0001” of the group subjected for sharing.

At S40, in response to the share request, which is received at the data transmitter/receiver 51 of the management system 50, the share request manager 58 of the management system 50 stores the terminal ID of the share request sender terminal, the terminal ID of the share request destination terminal, and the group ID, in the share request management table (FIG. 10).

As registration to the share request management table completes, at S41, the data transmitter/receiver 51 sends information indicating that the share request is accepted, to the terminal 10aa.

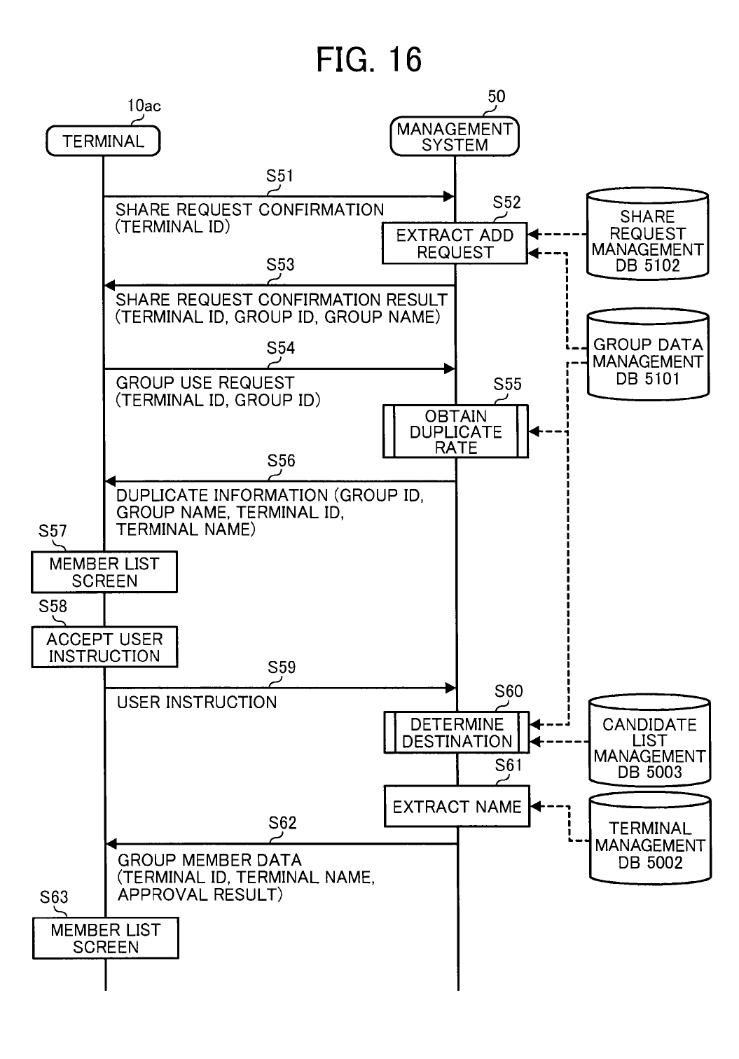

Referring now to FIG. 16, operation of adding one or more member terminals in the group member list as a candidate counterpart terminal for the share request destination terminal 10ac, performed by the communication system 1, is explained according to an example embodiment of the present invention. In this example, it is assumed that the share request destination terminal 10ac has performed S21 to S25 of FIG. 12 to complete the login process to the management system 50, before starting operation of FIG. 16.

At S51, the data transmitter/receiver 11 of the terminal 10ac sends share request confirmation information, which requests to send information indicating whether there is any share request for the terminal 10ac, to the management system 50 through the communications network 2. The share request confirmation information includes the terminal ID “01ac” assigned to the terminal 10ac. The management system 50 receives the share request confirmation information at the data transmitter/receiver 51.

At S52, the share request manager 58 of the management system 50 searches a share request management table (FIG. 10) using the terminal ID “01ac” as a search key, which is included in the share request confirmation information, to check if there is any share request addressed to the terminal 10ac. When the record is found, the share request manager 58 obtains the share request sender terminal ID “01aa” and the group ID “0001” that are associated with the share request destination terminal ID “01ac”.

At S53, the extractor 54 of the management system 50 searches the group data management table (FIG. 9A) using the group ID “0001” as a search key to obtain the group name “Project A” that is associated with the group ID “0001”. The data transmitter/receiver 51 transmits share request confirmation result information (“share request confirmation result”), which includes the share request sender terminal ID, the group ID, and the group name, to the terminal 10ac. The terminal 10ac receives the share request confirmation result at the data transmitter/receiver 11.

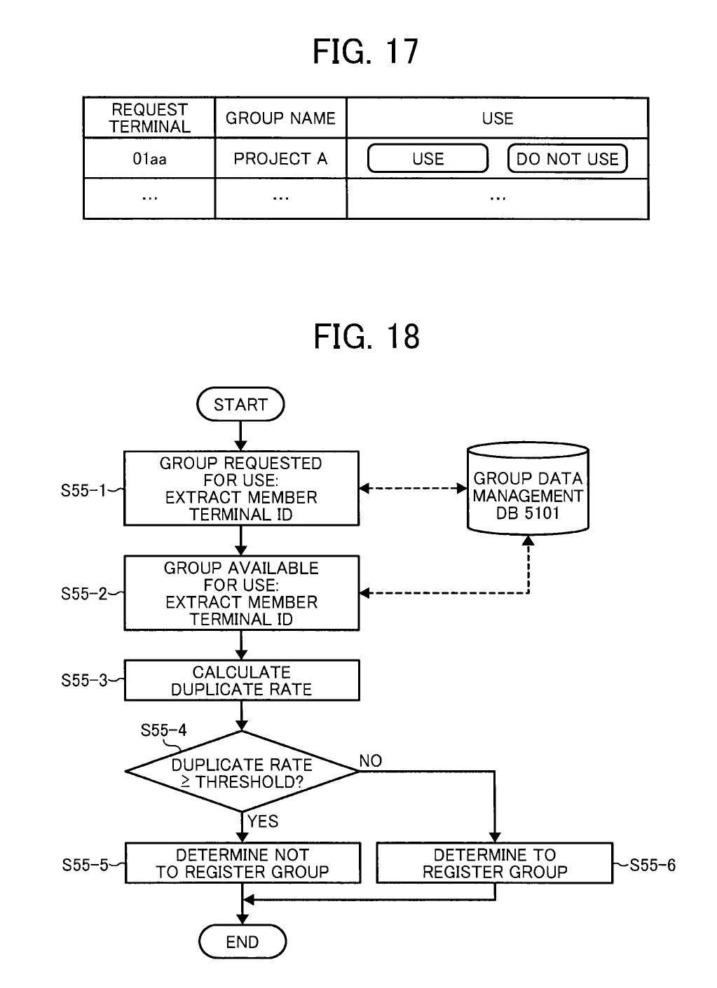

At S54, the display control 16 of the terminal 10ac generates a share request confirmation screen based on the share request confirmation result, and outputs the share request confirmation screen through the display 120 (FIG. 3), for example, as illustrated in FIG. 17. The share request confirmation screen includes information regarding a share request addressed to the terminal 10ac, such as the share request sender terminal (request terminal), the group name of the group subjected for sharing, and the graphical icons “USE” and “DO NOT USE” that can be selected by the user. In this example, as the “USE” icon is selected, the management system 50 registers one or more member terminals in the group member list, in association with the terminal 10ac, such that the one or more member terminals can be selected by the terminal 10ac to start communication.

In response to the user selection that selects the “USE” key on the share request confirmation screen of FIG. 17, through the operation key 108, the operation input 12 receives a request for using one or more member terminals in the selected group as a candidate counterpart terminal (“group use request”).

At S54, the data transmitter/receiver 11 of the terminal 10ac transmits group use request information (“group use request”) to the management system 50 through the communications network 2. The group use request information, which includes the terminal ID “01ac” of the terminal 10ac and the group ID, requests to use one or more member terminals in the selected group as a candidate counterpart terminal for the terminal 10ac. The management system 50 receives the group use request information at the data transmitter/receiver 51.

At S55, the management system 50 calculates a duplicate rate, between the member terminals in the group member list that is requested for use, and the member terminals being managed by the group data management DB 5101 for the terminal 10ac. Based on the calculation result, the management system 50 determines whether to register the group member list requested for use. FIG. 18 is a flowchart illustrating operation of determining whether to register the group member list requested for use, according to an example embodiment of the present invention.

At S55-1, the extractor 54 of the management system 50 searches the group data management table of FIG. 9A using the group ID “0001” of the group, which is subjected for sharing, as a search key, to obtain the member terminal IDs “01aa” “01ab” “01ac” and “01ca”.

At S55-2, the extractor 54 further searches the group data management table of FIG. 9A using the terminal ID of the use request sender terminal 10ac as a search key to obtain the member terminal IDs “01aa” “01ab” and “01ac”, which are included in one or more group member lists that can be used by the user terminal 10ac.

At S55-3, the calculator 61 calculates a duplicate rate, between the member terminals included in the group member list that the terminal 10ac requests for use, and the member terminals included in the group member list that can be used by the terminal 10ac. In this example, the duplicate rate is calculated as a ratio of the number of member terminals that is included in both of the member list requested for use and the member list that can be used, with respect to the number of member terminals included in the member list requested for use. In this example, the number of member terminals in the group member list requested for use corresponds to the number of member terminal IDs “01aa” “01ab” “01ac” and “01ca” of the group “0001”, which is 4. Of theses terminal IDs, the member terminal IDs of the terminals that can be used by the terminal Mac are “01aa” “01ab” and “01ac”, such that the number of the member terminals that are requested for use and are already registered for use by the terminal 10ac is 3. The calculator 61 thus obtains the duplicate rate of ¾=75%. The duplicate rate may be obtained in various other ways. For example, the duplicate rate may be calculated as a ratio of the number of member terminals included in the group member list, which have been already registered for use by the terminal 10ac, with respect to the number of member terminals that can be used by the terminal 10ac.

At S55-4, the registration determiner 62 compares between the calculated duplicate rate obtained by the calculator 61, and a threshold for duplicate rate. In this example, the duplicate rate threshold is previously stored in the memory 5000, such that the registration determiner 62 may obtain the threshold from the memory 5000 for comparison with the calculated duplicate rate. Alternatively, the threshold may be set according to user preference, for example, by the user at the terminal 10ac. For example, the threshold may be set at 70%.

At S55-4, when it is determined that the duplicate rate calculated by the calculator 61 is less than the threshold (“NO” at S55-4), the operation proceeds to S55-6. At S55-6, the registration determiner 62 determines to register the group member list that the terminal 10ac requests for use, as a group member list that can be used by the terminal 10ac. When it is determined that the duplicate rate calculated by the calculator 61 is equal to or greater than the threshold value (“YES” at S55-4), the operation proceeds to S55-5. At S55-5, the registration determiner 62 determines not to register the group member list that the terminal 10ac requests for use, as a group member list that can be used by the terminal 10ac.

Alternatively, the registration determiner 62 may determine to register the group member list requested for use, as a group member list that can be used by the terminal 10ac, when the duplicate rate calculated by the calculator 61 is equal to or less than the threshold. In such case, the registration determiner 62 determines not to register the group member list requested for use, as a group member list that can be used by the terminal 10ac, when the duplicate rate calculated by the calculator 61 is greater than the threshold.

Referring back to FIG. 16, when the duplicate rate is equal to or greater than the threshold (“YES” at S55-4), at S56, the data transmitter/receiver 51 of the management system 50 transmits duplicate information indicating that a group member list exists, which has more than a predetermined number of member terminals included in the group member list requested for use, to the terminal 10ac. In this example, the duplicate information may additionally include group information regarding the group that is requested for use, such as the group ID of the group corresponding to the group member list requested for use, the name of such group, the terminal ID of the member terminal, the owner terminal ID, and the name of the member terminal. Alternatively or additionally, the duplicate information may include group information regarding the registered group having similar information as the group requested for use, such as the group ID of the group corresponding to the group member list that can be used, the name of such group, the terminal ID of the member terminal, the owner terminal ID, and the name of the member terminal. The extractor 54 may search the group data management table of FIG. 9 using the group ID as a search key to obtain the group name. The extractor 54 may search the terminal management table of FIG. 7 using the member terminal 1D as a search key to obtain the name of the member terminal.

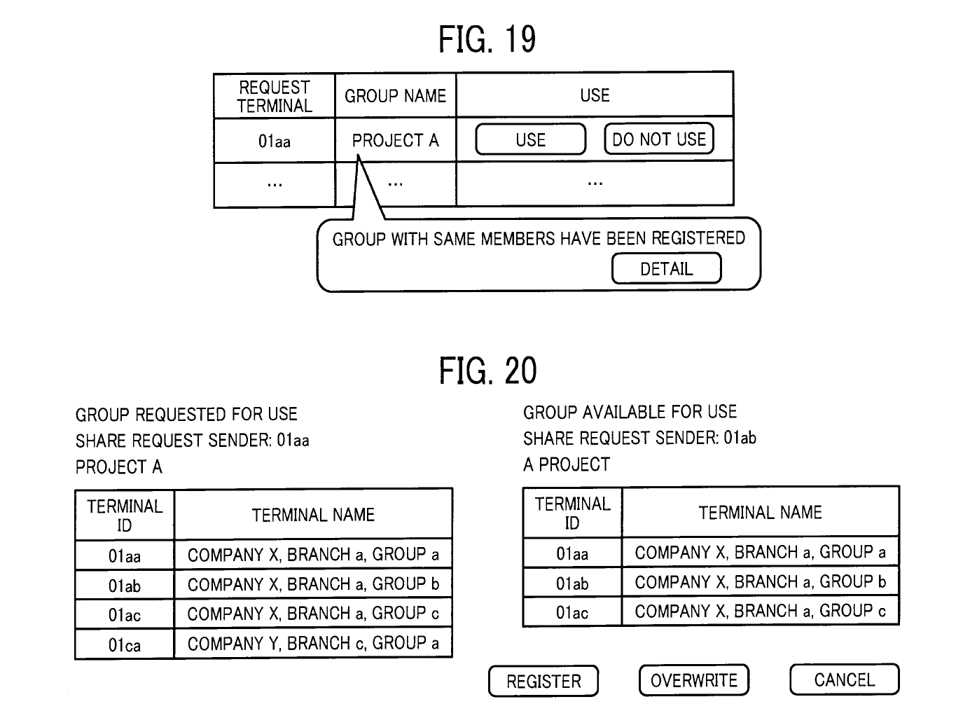

In response to the duplicate information received at the data transmitter/receiver 11, at S57, the display control 16 of the terminal 10ac outputs, through the display 120, information indicating that the group member list having the member terminals included in the requested group member list has been registered for use by the terminal 10ac, for example, as illustrated in FIG. 19.

FIG. 19 illustrates an example screen, with a message indicating that a group member list exists, which has more than a predetermined number of member terminals included in the requested group member list. In response to a user input that selects the “DETAIL” key, the display control 16 displays a screen of FIG. 20, based on the duplicate information transmitted from the management system 50.

FIG. 20 is an illustration of an example screen, which illustrates the group member list requested for use, and the group member list having more than a predetermined number of member terminals included in that group member list. Through the screen of FIG. 20, the terminal 10ac receives a user instruction regarding whether to register the group member list for use. More specifically, in this example, the screen of FIG. 20 includes the “REGISTER” key, “OVERWRITE” key, and “CANCEL” key. The “REGISTER” key, when selected, registers the group member list requested for use, as a group member list that can be used by the terminal 10ac. The “OVERWRITE” key, when selected, overwrites the group member list available for use, with the group member list requested for use. The “CANCEL” key, when selected, cancels registration of the group member list requested for use.

At S58, the operation input 12 receives a user instruction regarding whether to register the group member list requested for use, as the user at the terminal 10ac selects one of the keys. When the user at the terminal 10ac selects the “REGISTER” key, the operation input 12 receives a user instruction for registering the group member list requested for use, as a group member list that can be used by the terminal 10ac. When the user at the terminal 10ac selects “REPLACE” key, the operation input 12 receives a user instruction for registering the group member list requested for use, in replace of the group member list that can be used by the terminal 10ac, as a group member list that can be used by the terminal Mac. When the user at the terminal Mac selects the “CANCEL” key, the operation input 12 receives a user instruction for not registering the group member list requested for use.

At S59, the data transmitter/receiver 11 of the terminal 10ac transmits information indicating whether to register the group member list requested for use, to the management system 50, based on the user instruction received at the operation input 12.

In case the data transmitter/receiver 51 of the management system 50 receives information indicating that the group member list is not registered, the operation ends without registering the group member list requested for use. In this example, in response to the user selection that selects “CANCEL”, it is determined that the group member list is not to be registered.

In case the data transmitter/receiver 51 of the management system 50 receives information indicating that the group member list is to be registered, the operation proceeds to S60. In this example, in response to the user selection that selects “REGISTER” or “OVERWRITE”, it is determined that the group member list is to be registered. At SS60, the management system 50 determines whether any one of the member terminals included in the group member list requested for use is registered as a candidate counterpart terminal for the terminal Mac.

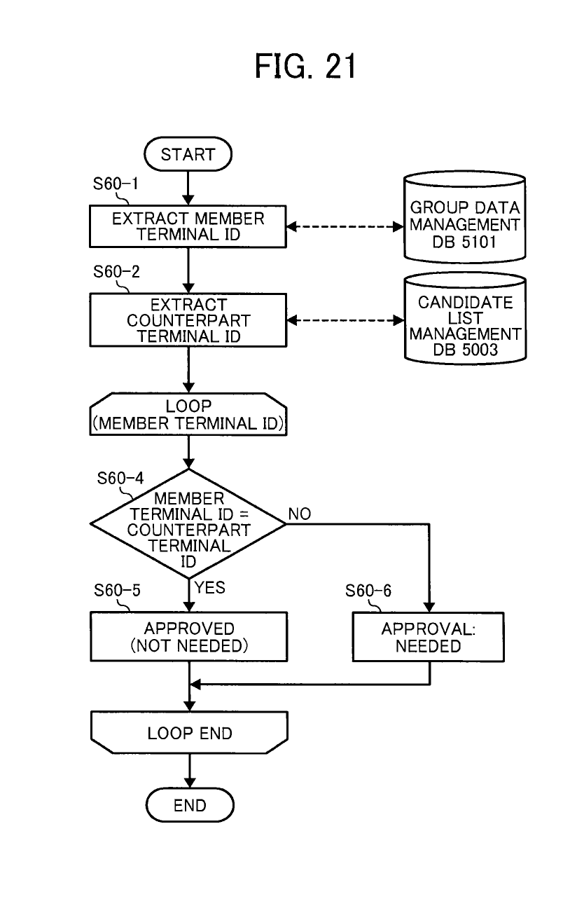

FIG. 21 is a flowchart illustrating operation of determining whether to request approval to add the member terminal, performed by the management system 50, according to an example embodiment of the present invention.

At S60-1, the extractor 54 of the management system 50 searches the group data management table of FIG. 9A using the group ID “0001”, which corresponds to the group member list requested for use, as a search key to obtain the member terminal IDs “01aa” “01ab” “01ac” and “01ca”.

At S60-2, the extractor 54 searches the candidate list management table of FIG. 8 using the terminal ID “01ac” included in the use request to obtain the terminal IDs “01aa” “01ac”, etc. of the candidate counterpart terminals, which can be selected by the terminal Mac.

For each of the member terminal IDs “01aa”, “01ab”, and “01ca” that are extracted, except for the terminal ID “01ac”, the destination determiner 55 performs operation of S60-4 to S60-6. More specifically, at S60-4, the destination determiner 55 determines whether the member terminal 1D extracted at S60-1 matches the candidate counterpart terminal ID for the terminal 10ac extracted at S60-2. Based on a match, the destination determiner 55 is able to determine whether the member terminal included in the group member list to be registered, has been managed using the candidate list management table of FIG. 8 as a candidate counterpart terminal for the request terminal 10ac. Through this operation, in this example, the destination determiner 55 determines that the member terminal IDs “01aa” and “01ab” are managed as a candidate counterpart terminal for the terminal 10ac, and that the member terminal ID “01ca” is not managed as a candidate counterpart terminal for the terminal 10ac.

When it is determined that the member terminal ID matches the candidate counterpart terminal ID for the terminal 10ac (“YES” at S60-4), the operation proceeds to S60-5. At S60-5, the approval determiner 56 determines that approval to add the member terminal 10 is not needed, as the member terminal has been registered as a candidate counterpart terminal for the terminal 10ac.

When it is determined that the member terminal ID does not match any one of the candidate counterpart terminal IDs for the terminal 10ac (“NO” at S60-4), the operation proceeds to S60-6. At S60-6, the approval determiner 56 determines that approval to add the member terminal 10 is needed.

Assuming that determination of whether approval to add the member terminal is needed is made for each member terminal extracted at S60-1, the operation of FIG. 21 ends to proceed to S61 of FIG. 16. At S61, the extractor 54 searches the terminal management table of FIG. 7 using the terminal ID of each member terminal, as a search key, to obtain the name corresponding to the terminal ID.

At S62, the data transmitter/receiver 51 of the management system 50 transmits the group member information including, for each member terminal, the terminal ID and the name of the member terminal, and information indicating the determination result of whether to obtain approval to add the member terminal, to the terminal 10ac. The data transmitter/receiver 11 of the terminal 10ac receives the group member information.

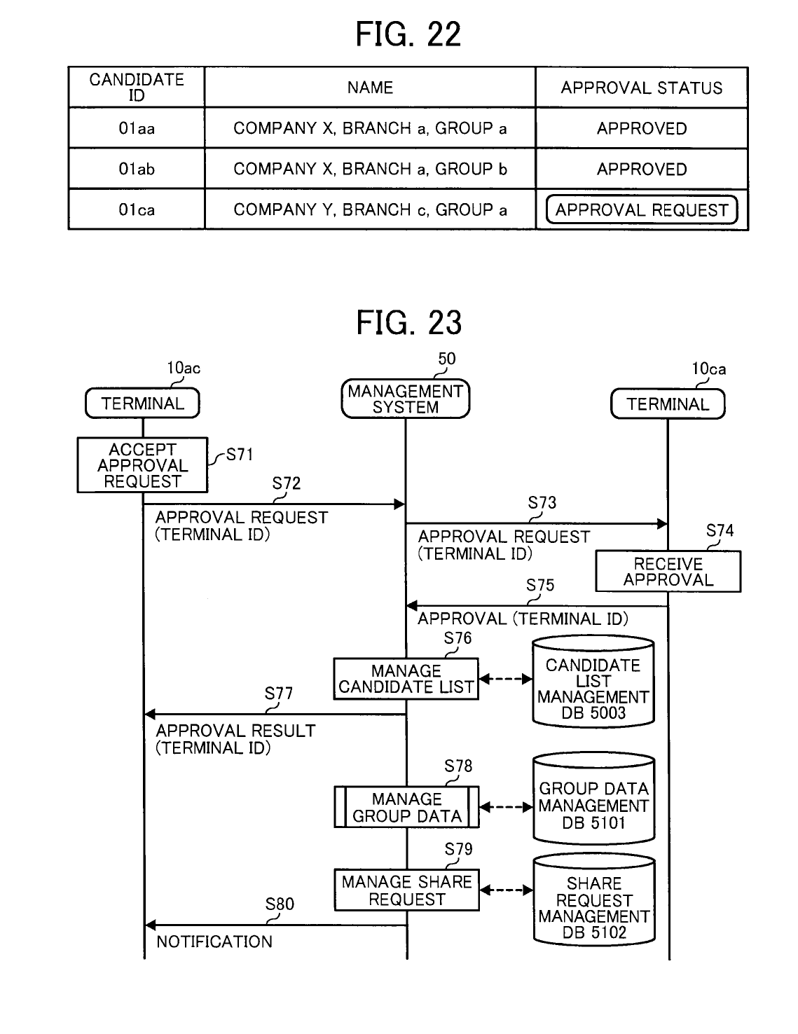

At S63, the display control 16 of the terminal 10ac generates a member list screen including a list of member terminals, and the determination result indicating whether to obtain approval to add the member terminal, based on the group member information. The display control 16 outputs, for example, a member list screen of FIG. 22 through the display 120 (FIG. 3). The member list screen of FIG. 22 illustrates that, for the unregistered member terminal 10ca, approval is needed, by providing an “approval request” key for selection by the user.

FIG. 23 is a data sequence diagram illustrating operation of obtaining approval to add the member terminal as a candidate counterpart terminal, performed by the management system 50, is explained according to an example embodiment of the present invention.

In response to selection of the approval request key of FIG. 22, by the user using the operation key 108, at S71, the operation input 12 of the terminal 10ac receives an approval request to add the unregistered terminal 10ca as a candidate counterpart terminal for the terminal 10ac.

At S72, the data transmitter/receiver 11 of the terminal 10ac transmits approval request information (“approval request”) to the management system 50 through the communications network 2. The approval request information includes the terminal ID “01ac” of the approval request sender terminal 10ac, and the terminal ID “01ca” of the approval request destination terminal 10ca. The management system 50 receives the approval request at the data transmitter/receiver 51.

At S73, the data transmitter/receiver 51 of the management system 50 transmits the approval request information to the approval request destination terminal 10ca. The approval request information includes the terminal ID “01ac” of the approval request sender terminal 10ac, and the terminal ID “01ca” of the approval request destination terminal 10ca. As described above, the approval request requests the terminal 10ca to approve addition of the terminal 10ca as a candidate counterpart terminal for the terminal 10ac. The terminal 10ca receives the approval request information at the data transmitter/receiver 11.

The terminal 10ca may request the user to approve or not to approve registration of the approval request destination terminal 10ca as a candidate counterpart terminal for the approval request sender terminal 10ac. In this example, it is assumed that the user approves addition of the terminal 10ca as a candidate counterpart terminal for the terminal 10ac.

In response to a user input through the operation key 108, at S74, the operation input 12 of the terminal 10ca receives approval to add the terminal 10ca as a candidate counterpart terminal for the terminal Mac.

At S75, the data transmitter/receiver 11 of the terminal 10ca transmits approval information, which indicates approval to add the terminal 10ca as a candidate counterpart terminal for the terminal 10ac, to the management system 50. The approval information includes the terminal ID “01ac” of the approval request sender terminal 10ac, and the terminal ID “01ca” of the approval request destination terminal 10ca. The management system 50 receives the approval information at the data transmitter/receiver 51.

At S76, the candidate list manager 57 of the management system 50 stores the terminal ID “01ca” of the terminal 10ca in association with the terminal ID “01ac” of the request terminal 10ac, in the candidate list management table (FIG. 8).

At S77, the data transmitter/receiver 51 of the management system 50 transmits approval result information (“approval result”), which indicates approval to add the terminal 10ca as a candidate counterpart terminal for the terminal 10ac, to the terminal 10ac. The approval result includes the terminal ID “01ac” of the approval request sender terminal 10ac, and the terminal ID “01ca” of the approval request destination terminal 10ca.

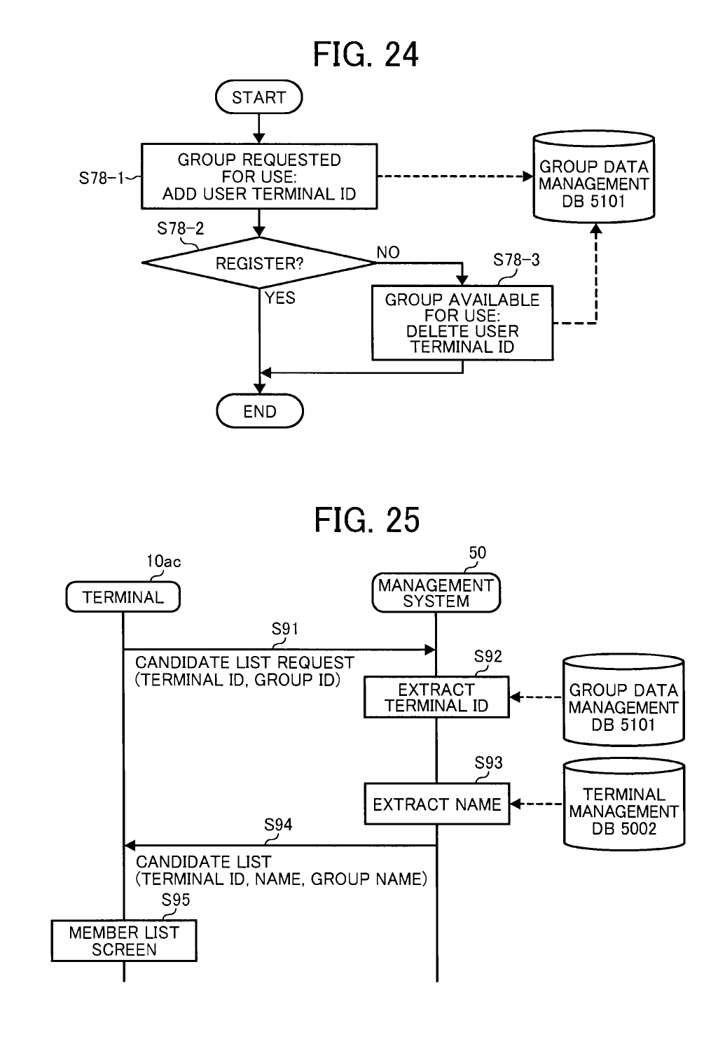

At S78, the group data manager 60 updates the group data management table of FIG. 9, for example, as described below referring to FIG. 24. FIG. 24 is a flowchart illustrating operation of updating the group data, performed by the group data manager 60, according to an example embodiment of the present invention.

At S78-1, the group data manager 60 stores the terminal ID “01ac” of the approval request sender terminal 10ac, as a user terminal ID of the group data management table of FIG. 9A, in association with the group ID “0001” of the group that corresponds to the group member list requested for use. Through this operation, the terminal ID “01ac” is entered in the “user terminal ID” field as illustrated in FIG. 9B.

At S78-2, the group data manager 60 determines whether the information indicating whether to register the group member list, which is obtained at the data transmitter/receiver 51 at S59, indicates to “register” the group member list. When it is determined that the information indicating to “register” the group member list requested for use is received (“YES” at S78-2), the operation of updating the group data management table ends. In such case, as illustrated in FIG. 9B, the group member list having the group ID “0001” is updated to additionally include the user terminal ID “01ac” of the terminal 10ac, such that this group member list can be used by the terminal 10ac.

When it is determined that the information indicating to “overwrite” the group member list available for use with the group member list requested for use is received (“NO” at S78-2), the operation proceeds to S78-3.

At S78-3, the group data manager 60 further deletes the user terminal ID “01ac”, from the group member list having the group ID “0003”, which is previously determined as the group member list available for use, for example, as illustrated in FIG. 9C. More specifically, the group member list with the group ID “0003” includes one or more member terminals, which have been also registered as member terminals of the group member list requested for use with the group ID “0001”. In such case, as illustrated in FIG. 9C, the group member list having the group ID “0001” is updated to additionally include the user terminal ID “01ac” of the terminal 10ac, such that this group member list can be used by the terminal 10ac. Further, the group member list having the group ID “0003” is updated to delete the user terminal ID “01ac” of the terminal 10ac, such that this group member list cannot be used by the terminal 10ac. Through this operation, the group member list available for use is replaced with the group member list requested for use.

Referring to FIG. 25, operation of processing a request for information regarding a candidate counterpart terminal based on the group information such as the group member list, performed by the communication system 1, is explained according to an example embodiment of the present invention.

At S91, the data transmitter/receiver 11 of the terminal 10ac transmits candidate list request information (“candidate list request”) to the management system 50 through the communications network 2. In this example, the candidate list request requests for candidate list information indicating one or more member terminals of a specific group that can be requested for communication. For example, the candidate list request includes the group ID that identifies the selected group, and the terminal ID of the terminal 10ac. The user at the terminal 10ac may select any one of the groups that are owned by the terminal 10ac or allowed for use by the terminal 10ac. The management system 50 receives the candidate list request at the data transmitter/receiver 51.

At S92, the extractor 54 of the management system 50 searches the group data management table of FIG. 9 using the group ID obtained from the candidate list request as a search key to obtain the member terminal ID and the group name.

At S93, the extractor 54 of the management system 50 searches the terminal management table of FIG. 7 using the member terminal ID, obtained at S92, as a search key to obtain the name of the member terminal.

At S94, the data transmitter/receiver 51 transmits candidate list information (“candidate list”) to the terminal 10ac. The candidate list includes the terminal ID and the terminal name of the member terminal, the group ID, and the group name. The terminal 10ac receives the candidate list at the data transmitter/receiver 11.

At S95, the display control 16 of the terminal 10ac generates a member list screen based on the candidate list information, and outputs the member list screen through the display 120. The member list screen includes the group name of the selected group, and the name of the member terminal belonging to the selected group.

Using the member list screen, the user at the terminal 10ac is able to select one or more of the counterpart terminals 10 to start communication, or all member terminals in the specific group at once. In response to the user input that selects the counterpart terminal through the operation input 12, the data transmitter/receiver 11 of the terminal 10ac transmits a communication start request to the management system 50, which requests to start communication with the selected counterpart terminal. The communication start request includes the terminal ID “01ac” of the terminal 10ac, and the terminal ID of the counterpart terminal.

In response to the communication start request, the management system 50 controls connection at least between the terminal 10ac and the counterpart terminal 10, for example, under control of the CPU 201. The terminal 10ac and the counterpart terminal 10 establish a communication session through the relay device 30 to transmit or receive various data such as image data and sound data, using any desired method, for example, as described in the description related to FIGS. 2 and 3A to 3C of U.S. Patent Application Publication No. 2013-0223292, the contents of which is incorporated herein by reference.

In the above-described example embodiments, the relay device 30, the management system 50, the program providing system 90, and the maintenance system 100 may each be implemented by a single computer. Alternatively, any number of parts, functions, or modules of the relay device 30, the management system 50, the program providing system 90, and the maintenance system 100 may be classified into a desired number of groups to be carried out by a plurality of computers.

For example, the management system 50 may be implemented by a computer functioning as a management apparatus, and a computer functioning as a web application server. In such case, the management apparatus may be provided with a candidate list management DB 5003. The web application server provides web application services to the terminal 10. Based on a request received through the web browser, the web application server may output an instruction for updating the candidate list to the management apparatus. The management apparatus and the web application server may be located within the same country, or located in different countries.

In case the program providing system 90 is implemented by the single computer, the program to be provided by the program providing system 90 may be transmitted, one module by one module, after dividing into a plurality of modules, or may be transmitted at once. In case the program providing system 90 is implemented as a plurality of computers, each computer may transmit each module that is stored in its memory, after the program is divided into a plurality of modules.

In the above-described example embodiments, a share request for sharing group information is requested, using the communication terminal 10 that may be used for videoconference. Alternatively, any desired information processing apparatus such as any type of PC such as a work station or a tablet, or a PDA such as a smart phone, may be used to request a share request. In such case, the information processing apparatus may have a functional structure that is substantially similar to the functional structure illustrated in FIG. 5, and the hardware structure as illustrated in FIG. 4.

In such case, the data transmitter/receiver 11 may be implemented by the network I/F 209 that operates in cooperation with the instructions from the CPU 201. The operation input 12 may be implemented by the keyboard 211 or the mouse 212. The login request 13 may be implemented by the instructions from the CPU 201. The imaging device 14 may be implemented by a camera, which may be incorporated or attached to the information processing apparatus. The sound input 15a may be implemented by a microphone, which may be incorporated or attached to the information processing apparatus. The sound output 15b may be implemented by a speaker, which may be incorporated or attached to the information processing apparatus. The display control 16 may be implemented by the display 208.

In the above-described example embodiments, the terminal ID is used as identification information that identifies any one of the request terminal, counterpart terminal, member terminal, owner terminal, and user terminal. In alternative to or in addition to the terminal ID, user identification (user ID) that identifies a user who operates the terminal 10 may be used. In such case, a user ID of a user who operates a specific terminal, such as the request terminal, counterpart terminal, member terminal, owner terminal, or user terminal, may be used.

In the above-described example embodiments, the candidate list management table (FIG. 8) stores the terminal ID for each one of one or more candidate counterpart terminals that can be selected by the request terminal 10 to have communication. Alternatively, any other information that can identify the candidate counterpart terminal may be stored. Examples of identification information for identifying a candidate counterpart terminal include, but not limited to, a telephone number of a candidate counterpart terminal, and an IP address indicating the network location of a candidate counterpart terminal. The group data management table (FIG. 9) or the share request management table (FIG. 10) may additionally store a telephone number or an IP address, in association with the member terminal ID, owner terminal ID, and user terminal ID. With the additional information, the management system 50 is able to easily contact the terminal.

A recording medium storing any one of the terminal control program, relay control program, and communication management program, or a storage device such as the HDD 204 that stores any one of the terminal control program, relay control program, and communication management program, or the program providing system 90 provided with the HD 204 storing any one of the terminal control program, relay control program, and communication management program, may be distributed within the country or to another country as a computer program product.

In the above-described example embodiments, the communication system is treated as a videoconference system. Alternatively, the communication system may be implemented as a teleconference system such as the IP teleconference system or the Internet teleconference system, or a computer system. Alternatively, the communication system may be implemented as a car navigation system. For example, the request terminal 10 may be implemented as a car navigation system that is installed onto an automobile. The counterpart terminal 10 may be implemented as a management terminal or server at a management center that manages the car navigation system or a car navigation system that is installed onto another automobile. In another example, the communication system may be implemented as a communication system having a portable phone, smart phone, tablet, game machine, etc. In such case, the terminal 10 may be implemented as the portable phone, smart phone, tablet, game machine, etc.

In the above-described examples, the contents data is assumed to include image data and sound data such as voice data. Alternatively, the contents data may include any other type of data that affects human senses of sight in alternative to image data, or any other type of data that affects human senses of hearing in alternative to voice data. Alternatively, the contents data may include any other type of data that affects human senses of sight, smell, taste, touch, and hearing. In case the contents data that affects human senses of touch, the terminal 10 may convey the contents data that reflects senses of touch that is felt by a user at the terminal 10 to another terminal 10 through the communication network 2. In case the contents data that affects human senses of smell, the terminal 10 may convey the contents data that affects senses of smell felt by a user at the terminal 10 to another terminal 10 through the communication network 2. In case the contents data that affects human senses of taste, the terminal 10 may convey the contents data that affects senses of taste felt by a user at the terminal 10 to another terminal 10 through the communication network 2.

Further, the contents data may only include one type of contents data selected from sight data such as image data, hearing data such as voice data, touch data, smell data, and taste data.

Further, in the above-described examples, the communication system is implemented as a videoconference system for use at offices. Other examples of use of the communication system include, but not limited to, meetings, casual conversation among family members or friends, and distribution of information in one direction.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Further, any of the above-described devices or units can be implemented as a hardware apparatus, such as a special-purpose circuit or device, or as a hardware/software combination, such as a processor executing a software program.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cashe memory of the CPU, and the RAM may function as a physical memory or a primary memory of the apparatus, while the HDD may function as a secondary memory of the apparatus.

What is claimed is:

1. A communication management system, comprising:
a receiver that receives a request for registering first candidate information for use by a communication terminal, from the communication terminal, the first candidate information indicating a first group of one or more member communication terminals;
a memory that stores second candidate information available for use by the communication terminal, the second candidate information indicating a second group of one or more member communication terminals; and
a processor that calculates a duplicate rate of member communication terminals, between the first candidate information and the second candidate information,
when the duplicate rate is at least less than a threshold, the processor determines to automatically register the first candidate information, and
when the duplicate rate is at least greater than the threshold, the processor determines not to automatically register the first candidate information.

2. The communication management system of claim 1, further comprising:
a transmitter that transmits information regarding the second candidate information to the communication terminal, when the duplicate rate is at least greater than the threshold.

3. The communication management system of claim 2, wherein:
the receiver further receives a user instruction indicating whether to register the first candidate information for use by the communication terminal, from the communication terminal, when the duplicate rate is at least greater than the threshold,
wherein the processor determines to register or not to register the first candidate information based on the user instruction.

4. The communication management system of claim 3, wherein, when the user instruction indicates to register the first candidate information, the processor registers the first candidate information in the memory.

5. The communication management system of claim 3, wherein, when the user instruction indicates to overwrite the second candidate information with the first candidate information, the processor overwrites the second candidate information with the first candidate information.

6. The communication management system of claim 1, wherein the duplicate rate is obtained as a ratio of a number of member terminals included in both of the first candidate information and the second candidate information, with respect to a number of member terminals included in the first candidate information.

7. A communication terminal, comprising:
a transmitter that transmits a request for registering first candidate information for use by the communication terminal, to a communication management system, the first candidate information indicating a first group of one or more member communication terminals;
a receiver that receives information regarding second candidate information available for use by the communication terminal, from the communication management system, the second candidate information indicating a second group of one or more member communication terminals, when a duplicate ratio of member communication terminals between the first candidate information and the second candidate information is at least greater than a threshold; and
a user interface that receives a user instruction indicating whether to register the first candidate information for use by the communication terminal,
wherein the transmitter transmits the user instruction indicating whether to register the first candidate information to the communication management system.

8. The communication terminal of claim 7, wherein the user instruction is one of:
a user instruction indicating to register the first candidate information for use by the communication terminal; and
a user instruction indicating to overwrite the second candidate information with the first candidate information.

9. A non-transitory recording medium storing a plurality of instructions which, when executed by one or more processors, cause the one or more processors to perform a method of managing candidate information comprising:
receiving a request for registering first candidate information for use by a communication terminal, from the communication terminal, the first candidate information indicating a first group of one or more member communication terminals;
storing second candidate information available for use by the communication terminal, the second candidate information indicating a second group of one or more member communication terminals;
calculating a duplicate rate of member communication terminals, between the first candidate information and the second candidate information;
when the duplicate rate is at least less than a threshold, determining to automatically register the first candidate information; and
when the duplicate rate is at least greater than the threshold, determining not to automatically register the first candidate information.
